(19) United States
(12) Patent Application Publication
(10) Pub. No.: US 2026/0164470 A1
(43) Pub. Date: Jun. 11, 2026

(54) RANDOM-ACCESS COMMUNICATION WITH TENSOR BASED MODULATION OF FIRST MESSAGE PART FOR NON-COHERENT DEMODULATION AND COHERENT DEMODULATION OF SECOND MESSAGE PART

(71) Applicant: HUAWEI TECHNOLOGIES CO., LTD., Shenzhen (CN)

(72) Inventors: Alexis Decurninge, Boulogne Billancourt (FR); Maxime Guillaud, Boulogne Billancourt (FR)

(73) Assignee: HUAWEI TECHNOLOGIES CO., LTD., Shenzhen (CN)

(21) Appl. No.: 18/971,213

(22) Filed: Dec. 6, 2024

Related U.S. Application Data
(63) Continuation of application No. PCT/EP2022/065320, filed on Jun. 7, 2022.

(51) Int. Cl. H04W 74/0833; H04B 7/0456; H04L 5/02; H04L 25/03

(52) U.S. Cl. CPC H04W 74/0833; H04B 7/0456; H04L 5/023; H04L 25/03178

(57) ABSTRACT

A transmitting device for random access communication, includes an encoding circuit configured to encode an input message into a first sequence of bits and a second sequence of bits, split the first sequence of bits into d blocks of bits and determine d vectors. The transmitting device includes a first mapping circuit configured to construct a first symbol vector by computing a Kronecker product of the d vectors and a second mapping circuit configured to map the second sequence of bits to a second symbol vector, a concatenation circuit configured to concatenate the first symbol vector and the second symbol vector into a baseband symbol vector, a modulation circuit configured to modulate the baseband symbol vector to generate a modulated symbol vector comprising modulated symbols, and an antenna configured to transmit each modulated symbols of the modulated symbol vector in a radio frequency signal to a receiving device.

### CROSS-REFERENCE TO RELATED APPLICATIONS

This application is a continuation of International Application No. PCT/EP2022/065320, filed on Jun. 7, 2022, the disclosure of which is hereby incorporated by reference in its entirety.

### FIELD

The present disclosure relates generally to the field of wireless communication; and more specifically, to a transmitting device, a receiving device, a communication apparatus comprising the transmitting device and the receiving device, and methods for random-access communication.

### BACKGROUND

With the rapid increase in the number of communication devices in a network, concerns about communication reliability have become prominent. Traditionally, multiple access methods with fixed resource assignments are used by conventional communication devices for communication of data in a network. In the fixed access methods, a given communication device is assigned dedicated time-frequency resources in order to send data via a communication channel. These conventional multiple access methods are less efficient in terms of channel utilization because sometimes the given communication device may not have any data to transmit in the dedicated time-frequency resources, resulting in a loss in terms of spectral efficiency.

In certain scenarios, instead of the conventional fixed access methods, conventional random-access methods are used for a comparatively better utilization of the communication channel. In the conventional random-access methods, a conventional communication device (e.g., a transmitter) is allowed to send data on the communication channel whenever it has some data to transmit. There is no need of a preassigned time slot or a fixed frequency for data transmission. The conventional random-access methods are typically classified into coherent and non-coherent methods. In coherent methods, the channel state is known to communication devices (i.e., both the transmitter and the receiver). In non-coherent methods, the channel state is supposed to be unknown to both the conventional transmitter and the conventional receiver. In an implementation scenario of the random-access methods, the conventional receiver receives massively transmitted messages from a number of the conventional transmitters which are active at that point of time. Moreover, in the so-called unsourced setting, the conventional receiver does not know the identity of the active conventional transmitters in advance since, the conventional transmitters are assumed to be randomly activated in said implementation scenario of the random-access methods (e.g., a massive random-access scenario). Currently, certain methods have been proposed to perform in such implementation scenarios of the random-access methods, such as pilot-based methods and non-coherent modulation. In the pilot-based methods, the available channel accesses are divided in two parts, a first part is dedicated to a non-orthogonal pilot sequence (e.g., columns of a compressed sensing matrix) used at a conventional receiver in order to perform activity detection and channel estimation. A second part is dedicated to a typical coherent modulation decoded at the conventional receiver by using the channels estimated depending on the first part. Although, in the non-coherent modulation, the whole set of channel uses is dedicated to a constellation and directly decoded at the conventional receiver without channel knowledge using the specific constellation structure. An example of the non-coherent modulation is tensor-based modulation in which the constellation is generated using a specific structure issued from rank-1 tensors. However, the aforementioned methods manifest sub-optimal performance in terms of the amount of data that can be encoded by each transmitter in the modulation (also known as spectral efficiency), and the number of the conventional transmitters (or users) that can be supported, especially for systems using the pilot-based methods. Thus, there exists a technical problem of an inadequate communication reliability and limited number of transmitters (or users) that can supported simultaneously, in the conventional random-access methods.

Therefore, in light of the foregoing discussion, there exists a need to overcome the aforementioned drawbacks associated with the conventional random-access methods.

### SUMMARY

The present disclosure provides a transmitting device, a receiving device, a communication apparatus comprising the transmitting device and the receiving device, and methods for random-access communication. The present disclosure provides a solution to the existing problem of the limited amount of data that can be encoded by each transmitter in the modulation and limited number of transmitters (or users) that can supported simultaneously, in the conventional random-access methods. An aim of the present disclosure is to provide a solution that overcomes at least partially the problems encountered in prior art, and provide an improved transmitting device, an improved receiving device, an improved communication apparatus comprising the improved transmitting device and the improved receiving device, and improved methods for random-access communication.

In one aspect, the present disclosure provides a transmitting device for random access communication, comprising an encoding circuit configured to encode an input message into a first sequence of bits and a second sequence of bits, split the first sequence of bits into d blocks of bits, where d>1, and determine d vectors, based on the d blocks of bits. The transmitting device further comprises a first mapping circuit configured to construct a first symbol vector by computing a Kronecker product of the d vectors to generate a rank-1 tensor structure of order d. The transmitting device further comprises a second mapping circuit configured to map the second sequence of bits to a vector of baseband symbols, and apply an allocation matrix to the vector of baseband symbols to generate a second symbol vector, where the allocation matrix is a precoding matrix based on the first sequence of bits. The transmitting device further comprises a concatenation circuit configured to concatenate the first symbol vector and the second symbol vector into a baseband symbol vector, a modulation circuit configured to modulate the baseband symbol vector to generate a modulated symbol vector comprising modulated symbols, and at least one antenna configured to transmit each modulated symbol of the modulated symbol vector in a radio frequency signal to a receiving device.

The disclosed transmitting device combines the tensor-based modulation (TBM) with the coherent modulation and hence, manifests an improved spectral efficiency over a conventional tensor-based modulation in case of large symbol size. Alternatively stated, the transmitting device transmits a part of information payload by use of tensor-based modulation and transmits rest of the information payload by use of coherent modulation. The disclosed transmitting device provides an improved spectral efficiency. Additionally, the transmitting device may be used in a block fading channel as well as in a non-block fading channel.

In an implementation form, the encoding circuit is configured to split the input message into a first message and a second message, encode the first message into the first sequence of bits, and encode the second message into the second sequence of bits.

The first sequence of bits and the second sequence of bits are used to generate the first symbol vector and the second symbol vector, respectively, by use of different vector symbol mappers.

In a further implementation form, the encoding circuit is configured to encode the input message into a main sequence of bits, and split the main sequence of bits into the first sequence of bits and the second sequence of bits.

By virtue of splitting the main sequence of bits into the first sequence of bits and the second sequence of bits, different vector symbol mappers can be used in order to generate the first symbol vector and the second symbol vector, respectively.

In a further implementation form, the encoding circuit is configured to use a binary code for encoding messages.

By virtue of encoding the input message according to the binary code, redundancy is added to the input message which makes the input message robust to the noise and different kind of interferences.

In a further implementation form, the encoding circuit is configured to select the precoding matrix from a fixed dictionary comprising matrices, where each of the matrices of the fixed dictionary is equal to one of a same unitary matrix, a same unitary matrix multiplied by a same permutation matrix, a same unitary matrix multiplied by a truncated permutation matrix from a set of non-disjoint truncated permutation matrices, a matrix from a set of matrices corresponding to subspaces of a Grassmannian space, or a matrix from a set of truncated unitary matrices. In a further implementation form, this selection of the precoding matrix by the encoding circuit is based on the first sequence of bits.

The selection of the precoding matrix from the fixed dictionary leads to a low complexity decoding process at the receiving device.

In a further implementation form, the modulation circuit is further configured to map the baseband symbol vector in a time-frequency grid associated with a plurality of time-frequency resources according to a pre-defined allocation matrix, associated with a multicarrier modulation, e.g. an Orthogonal Frequency-Division Multiplexing (OFDM) modulation.

The time-frequency mapping of each element of the first symbol vector enables the receiving device to more accurately estimate and compensate the timing and carrier frequency offsets and hence, the improved communication reliability is obtained in the communication system comprising the transmitting device and the receiving device in a non-block fading channel.

In a further implementation form, the first mapping circuit is further configured to multiply each of the d vectors by a unitary matrix, prior to computing the Kronecker product.

The use of the unitary matrix provides an additional degree of freedom in the design of sub-constellations. Moreover, an adequate choice of the unitary matrix enables the receiving device to accurately estimate and compensate the timing and carrier frequency offsets which further leads to the improved communication reliability.

In a further implementation form, the second mapping circuit is configured to map the second sequence of bits to the vector of baseband symbols by using a quadrature amplitude modulation or a phase shift keying modulation, or any state-of-the-art scalar modulation.

In a further implementation form, the concatenation circuit is further configured to multiply the result of the concatenation of the first symbol vector and the second symbol vector by a permutation matrix to form the baseband symbol vector.

The multiplication of the result of the concatenation of the first symbol vector and the second symbol vector by the permutation matrix to form the baseband symbol vector leads to an accurate estimation as well as compensation of the timing and carrier frequency offsets at the receiving device.

In another aspect, the present disclosure provides a receiving device for random access communication, comprising at least one antenna configured to receive a plurality of radio frequency signals concurrently from a plurality of transmitting devices, and a demodulation circuit configured to demodulate the received radio frequency signals into demodulated signals. The receiving device further comprises a splitting circuit configured to split the demodulated signals into first baseband signals and second baseband signals. The receiving device further comprises a separation circuit configured to generate a plurality of first estimated symbol vectors from the first baseband signals, using a rank-1 tensor structure of order d associated with each transmitting device, where d>1, and generate a plurality of estimated channel parameters associated with the plurality of transmitting devices and a plurality of estimated precoding matrices associated with the plurality of transmitting devices, based on the first baseband signals. The receiving device further comprises an equalizing circuit configured to generate a plurality of second estimated symbol vectors from the second baseband signals, based on the plurality of estimated precoding matrices and the plurality of estimated channel parameters. The receiving device further comprises a decoding circuit configured to decode each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices.

The receiving device provides an improved communication reliability and supports a large number of users simultaneously. Moreover, the receiving device detects a set of active transmitting devices among the plurality of transmitting devices as well as estimates the respective channels of the set of active transmitting devices among the plurality of transmitting devices by virtue of the separation circuit, and the equalizing circuit. Moreover, the equalizing circuit is configured to use the plurality of estimated precoding matrices and the plurality of estimated channel parameters to de-map the coherent modulation used at the transmitting device. Additionally, the receiving device may be used in a block fading channel as well as in a non-block fading channel.

In an implementation form, the decoding circuit comprises a plurality of first decoders each configured to decode one of the first estimated symbol vectors generated by the separation circuit to generate a plurality of first decoded messages, each first decoded message comprising a first sequence of bits corresponding to a first part of data associated with a corresponding transmitting device amongst the plurality of transmitting devices and a plurality of second decoders each configured to decode one of the second estimated symbol vectors generated by the equalization circuit to generate a plurality of second decoded messages, each of the second decoded messages comprising a second sequence of bits corresponding to a second part of data associated with a corresponding transmitting device amongst the plurality of transmitting devices.

In a further implementation form, the decoding circuit comprises a plurality of decoders each configured to receive one of the first estimated symbol vectors and one of the second estimated symbol vectors, concatenate the received first and second estimated symbol vectors into a concatenated estimated symbol vector, and decode the concatenated estimated symbol vector to generate a plurality of decoded messages.

In a further implementation form, the splitting circuit is further configured to apply a predefined permutation matrix to the demodulated signals to generate the first baseband signals and the second baseband signal.

In a further implementation form, the separation circuit is further configured to estimate a time offset and a frequency offset in each of the first estimated symbol vectors to generate a plurality of time offsets and a plurality of frequency offsets, and apply a time offset compensation, based on the corresponding time offset, and a frequency offset compensation, based on the corresponding frequency offset, to the corresponding first estimated symbol vector.

The estimation of the time offsets and the frequency offsets leads to more accurate compensation of the time offset and the frequency offset in each of the first estimated symbol vectors.

Besides, the equalizing circuit is further configured to generate each of the second estimated symbol vectors based on the plurality of time offsets, the plurality of frequency offsets, the plurality of estimated precoding matrices and the plurality of estimated channel parameters.

In a yet another aspect, the present disclosure provides a communication apparatus, comprising the transmitting device and the receiving device.

The communication apparatus achieves all the advantages and technical effects of the transmitting device as well as the receiving device of the present disclosure.

In a yet another aspect, the present disclosure provides a method for random-access communication. The method comprises acquiring, by an encoding circuit of a transmitting device, an input message and encoding, by the encoding circuit, the input message into a first sequence of bits and a second sequence of bits. The method further comprises splitting, by the encoding circuit, the first sequence of bits in d blocks of bits, where d>1 and determining, by the encoding circuit, d vectors based on the d blocks of bits. The method further comprises constructing a first symbol vector, by a first mapping circuit of the transmitting device, by computing the Kronecker product of the d vectors to generate a rank-1 tensor structure of order d and mapping, by a second mapping circuit of the transmitting device, the second sequence of bits to a vector of baseband symbols. The method further comprises applying, by the second mapping circuit, an allocation matrix to the vector of baseband symbols to generate a second symbol vector, where the allocation matrix is a precoding matrix based on the first sequence of bits and concatenating, by a concatenation circuit of the transmitting device, the first symbol vector and the second symbol vector into a baseband symbol vector. The method further comprises modulating, by a modulation circuit of the transmitting device, the baseband symbol vector to generate a modulated symbol vector comprising modulated symbols, and transmitting, by at least one antenna of the transmitting device, each modulated symbol of the modulated symbol vector in a radio frequency signal to a receiving device.

The method achieves all the advantages and technical effects of the transmitting device of the present disclosure.

In a yet another aspect, the present disclosure provides a method for random access communication. The method comprises receiving, by at least one antenna of a receiving device, a plurality of radio frequency signals concurrently from a plurality of transmitting devices, demodulating, by a demodulation circuit of the receiving device, the received radio frequency signals into demodulated signals, and splitting, by a splitting circuit of the receiving device, the demodulated signals into first baseband signals and second baseband signals, using a rank-1 tensor structure of order d associated with each transmitting device, where d>1. The method further comprises generating, by the separation circuit, a plurality of estimated channel parameters associated with the plurality of transmitting devices and a plurality of estimated precoding matrices associated with the plurality of transmitting devices, based on the first baseband signals and estimating, by an equalizing circuit of the receiving device, a plurality of second estimated symbol vectors from the second baseband signals, based on the plurality of estimated precoding matrices and the plurality of estimated channel parameters, and decoding, by a decoding circuit, each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices.

The method achieves all the advantages and technical effects of the receiving device of the present disclosure.

In a yet another aspect, the present disclosure provides a computer program product comprising program instructions for performing the methods for random access communication, when executed by one or more processors in a computer system.

In a yet another aspect, the present disclosure provides a computer system comprising one or more processors and one or more memories, the one or more memories storing program instructions which, when executed by the one or more processors, cause the one or more processors to execute the methods for random access communication.

The one or more processors of the computer system achieve all the advantages and technical effects of the methods after execution of the methods for random access communication.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a network environment diagram of a system with a plurality of transmitting devices and a receiving device, in accordance with an embodiment of the present disclosure;

FIG. 2A is a block diagram that illustrates various exemplary components of a transmitting device, in accordance with an embodiment of the present disclosure;

FIG. 2B is a block diagram that illustrates various exemplary components of a transmitting device, in accordance with another embodiment of the present disclosure;

FIG. 2C is a block diagram that illustrates various exemplary components of a transmitting device, in accordance with yet another embodiment of the present disclosure;

FIG. 3 is an illustration of time-frequency mapping of a modulated symbol vector in a time-frequency grid, in accordance with an embodiment of the present disclosure;

FIG. 4 is a flowchart of a method for a random-access communication, in accordance with an embodiment of the present disclosure;

FIG. 5 is a block diagram that illustrates various exemplary components of a receiving device, in accordance with an embodiment of the present disclosure;

FIG. 6 is an illustration of a receiving device, in accordance with an embodiment of the present disclosure;

FIG. 7 is an illustration of a separation circuit of a receiving device, in accordance with an embodiment of the present disclosure;

FIG. 8 is an illustration of an equalizing circuit of a receiving device, in accordance with an embodiment of the present disclosure;

FIG. 9 is another illustration of a receiving device, in accordance with another embodiment of the present disclosure;

FIGS. 10A and 10B collectively is a flowchart of a method for random access communication, in accordance with an embodiment of the present disclosure;

FIG. 11 is a block diagram that illustrates various exemplary components of a communication apparatus, in accordance with an embodiment of the present disclosure; and

FIG. 12 is a graphical representation that illustrates variation of block error rate (BLER) with respect to signal-to-noise ratio (SNR) for a mixed tensor-based modulation and coherent modulation and a typical tensor-based modulation in case of large payloads, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

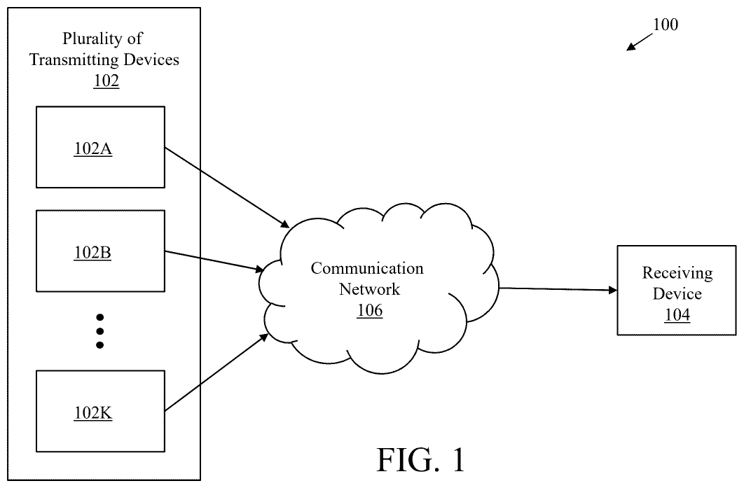

FIG. 1 is a network environment diagram of a system with a plurality of transmitting devices and a receiving device, in accordance with an embodiment of the present disclosure. With reference to FIG. 1, there is shown a network environment of a system 100 that includes a plurality of transmitting devices 102 and a receiving device 104. There is further shown a communication network 106. The plurality of transmitting devices 102 includes K transmitting devices, such as a first transmitting device 102A, a second transmitting device 102B, and up to a K-th transmitting device 102K.

Each of the plurality of transmitting devices 102 may include suitable logic, circuitry, interfaces and/or code that is configured to communicate with the receiving device 104 via the communication network 106 (e.g., a propagation channel). Examples of each of the plurality of transmitting devices 102 may include, but are not limited to, an Internet-of-Things (IOT) device, a smart phone, a machine type communication (MTC) device, a computing device, an evolved universal mobile telecommunications system (UMTS) terrestrial radio access (E-UTRAN) NR-dual connectivity (EN-DC) device, a server, an IoT controller, a drone, a customized hardware for wireless telecommunication, a transmitter, or any other portable or non-portable electronic device. In the system 100, each of the plurality of transmitting devices 102 has a single antenna for communication with the receiving device 104. However, in another implementation of the system 100, each of the plurality of transmitting devices 102 may have more than one antenna for communication with the receiving device 104.

The receiving device 104 may include suitable logic, circuitry, interfaces and/or code that is configured to receive one or more radio frequency signals concurrently from the plurality of transmitting devices 102, via the communication network 106. Examples of the receiving device 104 may include, but are not limited to, an Internet-of-Things (IOT) controller, a base station, a server, a smart phone, a customized hardware for wireless telecommunication, a receiver, or any other portable or non-portable electronic device. In the system 100, the receiving device 104 has more than one antenna for communication with the plurality of transmitting devices 102.

The communication network 106 includes a medium (e.g., a communication channel) through which the plurality of transmitting devices 102, potentially communicates with the receiving device 104. Examples of the communication network 106 may include, but are not limited to, a cellular network (e.g., a 2G, a 3G, long-term evolution (LTE) 4G, a 5G, or 5G NR network, such as sub 6 GHz, cmWave, or mmWave communication network), a wireless sensor network (WSN), a cloud network, a Local Area Network (LAN), a vehicle-to-network (V2N) network, a Metropolitan Area Network (MAN), and/or the Internet. Each of the plurality of transmitting devices 102 in the network environment is configured to connect to the receiving device 104, in accordance with various wireless communication protocols. Examples of such wireless communication protocols, communication standards, and technologies may include, but are not limited to, IEEE 802.11, 802.11p, 802.15, 802.16, 1609, Worldwide Interoperability for Microwave Access (Wi-MAX), Transmission Control Protocol and Internet Protocol (TCP/IP), User Datagram Protocol (UDP), Hypertext Transfer Protocol (HTTP), Long-term Evolution (LTE), File Transfer Protocol (FTP), Enhanced Data GSM Environment (EDGE), Voice over Internet Protocol (VOIP), a protocol for email, instant messaging, and/or Short Message Service (SMS), and/or other cellular or IoT communication protocols.

Additionally, a random number of the plurality of transmitting devices 102 may be active at a time and may be configured to transmit a plurality of radio frequency signals concurrently to the receiving device 104 via the communication network 106. Therefore, the system 100 may also be referred to as an exemplary implementation of a massive random-access communication in which the plurality of transmitting devices 102 transmits the plurality of radio frequency signals concurrently to the receiving device 104. Moreover, each of the plurality of transmitting devices 102 transmits the plurality of radio frequency signals concurrently to the receiving device 104 without any prior resource request (or grant).

Moreover, in an implementation of the system 100, the communication network 106 may be configured to behave like a block fading channel between the plurality of transmitting devices 102 and the receiving device 104. Alternatively stated, the plurality of transmitting devices 102 and the receiving device 104 are considered to be perfectly synchronized with each other and therefore, no timing and carrier frequency offsets are present in the system 100. In another implementation of the system 100, where there is no block fading channel between the plurality of transmitting devices 102 and the receiving device 104 and therefore, timing and carrier frequency offsets are present at the plurality of transmitting devices 102 and are compensated at the receiving device 104 in order to reduce probability of decoding error and obtain an adequate communication reliability in the system 100.

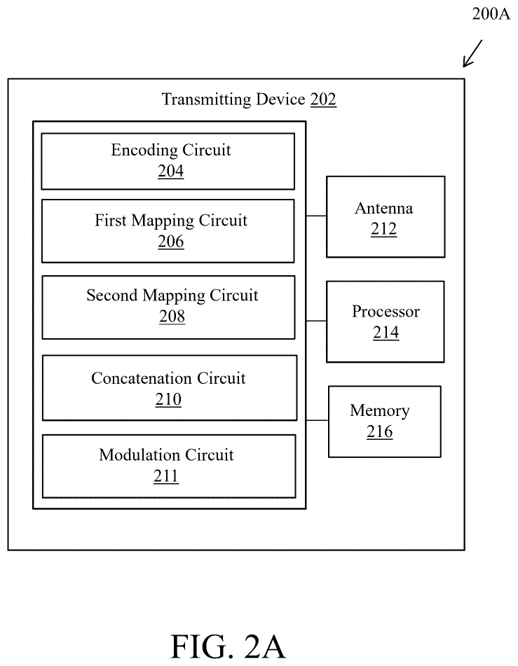

FIG. 2A is a block diagram that illustrates various exemplary components of a transmitting device, in accordance with an embodiment of the present disclosure. FIG. 2A is described in conjunction with elements from FIG. 1. With reference to FIG. 2A, there is shown a block diagram 200A of a transmitting device 202 that includes an encoding circuit 204, a first mapping circuit 206, a second mapping circuit 208, a concatenation circuit 210, a modulation circuit 211, an antenna 212, a processor 214 and a memory 216. In this implementation, the processor 214 and the memory 216 are separated. In another implementation, the memory 216 can be part of the processor 214, such as a level 1 cache memory.

Besides, in an implementation, the encoding circuit 204, the first mapping circuit 206, the second mapping circuit 208, the concatenation circuit 210, and the modulation circuit 211 may be a part of the processor 214. In another implementation, each of the encoding circuit 204, the first mapping circuit 206, the second mapping circuit 208, the concatenation circuit 210, and the modulation circuit 211 are separate circuits or modules (and may not be a part of the processor 214). The encoding circuit 204, the first mapping circuit 206, the second mapping circuit 208, the concatenation circuit 210, and the modulation circuit 211 are communicatively coupled to the antenna 212, the processor 214 and the memory 216. In this embodiment, the transmitting device 202 includes a single antenna, such as the antenna 212. However, in other embodiments, the transmitting device 202 may include multiple antennas.

The transmitting device 202 corresponds to one of the plurality of transmitting devices 102 (of FIG. 1), such as the K-th transmitting device 102K. The transmitting device 202 may be configured to communicate with the receiving device 104 (of FIG. 1).

The encoding circuit 204 may include suitable logic, circuitry, and/or interfaces that is configured to acquire an input message and encode the input message into a first sequence of bits and a second sequence of bits. In an implementation, the encoding circuit 204 may be a binary encoder. The encoding circuit 204 is described in detail, for example, in FIGS. 2B and 2C.

The first mapping circuit 206 may include suitable logic, circuitry, and/or interfaces that is configured to construct a first symbol vector by computing a Kronecker product of d vectors to generate a rank-1 tensor structure of order d.

The second mapping circuit 208 may include suitable logic, circuitry, and/or interfaces that is configured to map the second sequence of bits to a vector of baseband symbols.

The concatenation circuit 210 may include suitable logic, circuitry, and/or interfaces that is configured to concatenate the first symbol vector and a second symbol vector into a baseband symbol vector.

The modulation circuit 211 may include suitable logic, circuitry, and/or interfaces that is configured to generate a modulated symbol vector comprising modulated symbols.

The antenna 212 may include suitable logic, circuitry, and/or interfaces that is configured to transmit each modulated symbol of the modulated symbol vector in a radio frequency signal to the receiving device 104 (of FIG. 1). Examples of the antenna 212 may include, but are not limited to, a radio frequency transceiver, a network interface, a telematics unit, or any antenna suitable for use in an IoT device, an IoT controller, a user equipment, a repeater, a base station or other portable or non-portable communication devices. The antenna 212 may wirelessly communicate by use of various wireless communication protocols.

The processor 214 may include suitable logic, circuitry, and/or interfaces that is configured to execute instructions stored in the memory 216. Examples of the processor 214 may include, but are not limited to an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 214 may refer to one or more individual processors, processing devices, a processing unit that is part of a machine.

The memory 216 may include suitable logic, circuitry, and/or interfaces that is configured to store machine code and/or instructions executable by the processor 214. The memory 216 may temporally store one or more modulated symbol vectors, which are then transmitted by the antenna 212 in form of one or more radio frequency signals to the receiving device 104. Examples of implementation of the memory 216 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The memory 216 may store an operating system and/or a computer program product to operate the transmitting device 202. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

FIG. 2B is a block diagram that illustrates various exemplary components of a transmitting device, in accordance with another embodiment of the present disclosure. FIG. 2B is described in conjunction with elements from FIGS. 1 and 2A. With reference to FIG. 2B, there is shown a block diagram of the transmitting device 202.

In operation, the transmitting device 202 is configured for random-access communication with the receiving device 104 (of FIG. 1). The transmitting device 202 comprises the encoding circuit 204 that is configured to encode an input message into a first sequence of bits and a second sequence of bits. In an implementation, the encoding circuit 204 of the transmitting device 202 is configured to acquire the input message, for example, a binary message m of B bits. In response to acquiring the input message (e.g., the binary message, m=1010001), the transmitting device 202 outputs a modulated symbol vector, v of dimension T, where T is the number of channel uses. Furthermore, the encoding circuit 204 is configured to encode the input message (i.e., the binary message, m=1010001) into the first sequence of bits and the second sequence of bits. In an implementation, the encoding circuit 204 may be configured to split the input message (i.e., the binary message, m=1010001) into a first message and a second message and thereafter, encode the first message into the first sequence of bits and encode the second message into the second sequence of bits, as shown in FIG. 2B. In another implementation, the encoding circuit 204 may be configured to encode the input message (i.e., the binary message, m=1010001) into a main sequence of bits, and split the main sequence of bits into the first sequence of bits and the second sequence of bits, described in detail, for example, in FIG. 2C.

In accordance with an embodiment, the encoding circuit 204 is configured to split the input message into a first message and a second message, encode the first message into the first sequence of bits, and encode the second message into the second sequence of bits. As shown in FIG. 2B, the encoding circuit 204 is configured to split the input message (i.e., the binary message, m=1010001) into the first message (may also be represented as m₁, where m₁=101) and the second message (may also be represented as m₂, where m₂=0001). The first message (i.e., m₁=101) and the second message (i.e., m₂=0001) has Bₚ and B_{q} bits, respectively, in such a way that the Bₚ+B_{q}=B bits of the input message (i.e., the binary message, m=1010001). Thereafter, the encoding circuit 204 is configured to encode the first message (i.e., m₁=101) into the first sequence of bits (may also be represented as μ₁) and the second message (i.e., m₂=0001) into the second sequence of bits (may also be represented as μ₂). The first sequence of bits (i.e., μ₁) and the second sequence of bits (i.e., μ₂) has the number of encoded bits as

$${B}_{p}^{′} and {B}_{q}^{′} ,$$

respectively.

In accordance with an embodiment, the encoding circuit 204 is configured to use a binary code for encoding messages. In an implementation, the encoding circuit 204 may be configured to encode the first message (i.e., m₁=101) and the second message (i.e., m₂=0001) into the first sequence of bits (i.e., μ₁) and the second sequence of bits (i.e., μ₂), respectively, by use of binary codes, for example, source codes, channel codes, and the like. The channel codes may include low-density parity check (LDPC) codes, Turbo codes, Viterbi codes, and the like.

The encoding circuit 204 of the transmitting device 202 is further configured to split the first sequence of bits into d blocks of bits, where d>1, and determine d vectors, based on the d blocks of bits. Furthermore, the encoding circuit 204 is configured to split the first sequence of bits (i.e., μ₁) into the d blocks, where d is an arbitrary number and greater than 1. For example, in a case, the first sequence of bits (i.e., μ₁) may have eleven bits as 00110101011 and the first sequence of bits (i.e., μ₁) is split into d blocks in such a way that a first block has three bits

$$( e . g . , {μ}_{1}^{′} = 001 ) ,$$

a second block has three bits

$$( e . g . , {μ}_{2}^{′} = 101 ) ,$$

a third block has three bits

$$( e . g . , {μ}_{3}^{′} = 010 ) ,$$

and a fourth block has last two bits

$$( e . g . , {μ}_{4}^{′} = 11 ) .$$

This way, the first sequence of bits (i.e., μ₁) is split into four blocks. Thereafter, the encoding circuit 204 is configured to determine the d vectors on the basis of the d block of bits. In the aforementioned case, d is equal to four and the encoding circuit 204 is configured to determine the four vectors. The first block

$$( i . e . , {μ}_{1}^{′} = 001 )$$

is used to generate a first vector (may also be represented as x₁). Similarly, the second block

$$( i . e . , {μ}_{2}^{′} = 101 ) ,$$

the third block

$$( i . e . , {μ}_{3}^{′} = 010 )$$

and the fourth block

$$( i . e . , {μ}_{4}^{′} = 11 )$$

is used to generate the second vector (may also be represented as x₂), the third vector (may also be represented as x₃), and the fourth vector (may also be represented as x₄), respectively. Similarly, a d-th block

$$( e . g . , {μ}_{d}^{′} )$$

is used to generate a d-th vector (may also be represented as x_{d}). Each of the generated d vectors (i.e., x₁, x₂, . . . , x_{d}) is a pᵢ-dimensional vector and the generated d vectors (i.e., x₁, x₂, . . . , x_{d}) corresponds to a number of sub-constellations (i.e., C₁, C₂, . . . , C_{d}). The generation of the d vectors on the basis of the d blocks of bits may also be referred to as vector symbol mapping and hence, the encoding circuit 204 may also be referred to as a vector symbol mapper circuit.

The first mapping circuit 206 is configured to construct a first symbol vector by computing a Kronecker product of the d vectors to generate a rank-1 tensor structure of order d. The first mapping circuit 206 is configured to construct the first symbol vector by computing the Kronecker product of the d vectors (i.e., x₁, x₂, . . . , x_{d}) to generate the rank-1 tensor structure of order d. The Kronecker product is a form of matrix multiplication and is represented by a mathematical notation ⊗. The Kronecker product is also known as a tensor product (or a direct product). The use of the Kronecker product is beneficial as the dimensions of a plurality of matrices being multiplied together on the basis of the Kronecker product do not need to have any relation with each other. The Kronecker product of the d vectors (i.e., x₁, x₂, . . . , x_{d}) is represented as x₁⊗ . . . ⊗x_{d}. The constructed first symbol vector has a multi-dimensional data structure. Moreover, the constructed first symbol vector carries the same information as the input message (i.e., the binary message, m) acquired by the encoding circuit 204. The constructed first symbol vector may also be referred to as the rank-1 tensor structure of order d which means that the constructed first symbol vector may be construed as a d-dimensional array of real and complex numbers. The d-dimensional array of real or complex numbers is of respective dimensions p₁ . . . p_{d} (which can be denoted as “a tensor of order “d” and size “p₁× . . . ×p_{d}”). The

$$p = {\prod }_{i = 1}^{d} {p}_{i}$$

numbers contained in the tensor structure can also be stored sequentially (in a predefined order) in a vector of size

$$p = {\prod }_{i = 1}^{d} {p}_{i} .$$

Any tensor structure that can be potentially denoted as (x₁⊗ . . . ⊗x_{d}), where “x₁ . . . x_{d}” refers to vectors with respective dimensions p₁ . . . p_{d} is usually called the rank-1 tensor structure. In a case where a tensor structure can be denoted as a sum of at least n vectors, it is potentially deemed as a rank-n tensor. The use of the Kronecker product is advantageous as it results in a definite and fixed tensor structure of the first symbol vector (i.e., a definite multi-dimensional data structure), which simplifies a waveform design for random-access communication.

The second mapping circuit 208 is configured to map the second sequence of bits to a vector of baseband symbols, and apply an allocation matrix to the vector of baseband symbols to generate a second symbol vector, where the allocation matrix is a precoding matrix based on the first sequence of bits. The second mapping circuit 208 is configured to map the second sequence of bits (i.e., μ₂) to the vector of baseband symbols (may also be represented as a∈ [symbol] ^{q}) of dimensions q using a coherent modulation. Therefore, the second mapping circuit 208 may also be referred to as coherent vector symbol mapper. Furthermore, the second mapping circuit 208 is configured to apply the allocation matrix (may also be represented as U) to the vector of baseband symbols (i.e., a) to generate the second symbol vector (may also be referred to as Ua). The allocation matrix (i.e., U) is also referred to as the precoding matrix that is determined on the basis of the first sequence of bits (i.e., μ₁) using a precoder selection. The first sequence of bits (i.e., μ₁) is used to determine a (T−p)×q dimensional matrix as U=U_{μ}_{₁} corresponding to the μ₁-th matrix in a fixed dictionary

$$\{ {U}_{1} , … , {U}_{{2}^{{B}_{p}^{′}}} \} ,$$

where the first sequence of bits (i.e., μ₁) and its integer representatives are confounded in between 1 and

$${2}^{{B}_{p}^{′}} .$$

In accordance with an embodiment, the second mapping circuit 208 is configured to map the second sequence of bits to the vector of baseband symbols by using a quadrature amplitude modulation or a phase shift keying modulation. In an implementation, the second mapping circuit 208 may be configured to map the second sequence of bits (i.e., μ₂) to the vector of baseband symbols (i.e., a) by using the quadrature amplitude modulation (QAM). Alternatively stated, each scalar element of the vector of modulated symbols (i.e., a) is generated using the QAM symbol. In another implementation, the second mapping circuit 208 may be configured to map the second sequence of bits (i.e., μ₂) to the vector of baseband symbols (i.e., a) by using the phase shift keying (PSK) modulation. Alternatively stated, each scalar element of the vector of baseband symbols (i.e., a) is generated using the PSK symbol.

In accordance with an embodiment, the encoding circuit 204 is configured to select the precoding matrix from a fixed dictionary comprising matrices, where each of the matrices of the fixed dictionary is equal to one of a same unitary matrix, a same unitary matrix multiplied by a same permutation matrix, a same unitary matrix multiplied by a truncated permutation matrix from a set of non-disjoint truncated permutation matrices, a matrix from a set of matrices corresponding to subspaces of a Grassmannian space, or a matrix from a set of truncated unitary matrices. The encoding circuit 204 is configured to select the precoding matrix (i.e., U) from the fixed dictionary

$$\{ {U}_{1} , … , {U}_{{2}^{{B}_{p}^{′}}} \}$$

where, the fixed dictionary comprises a number of matrices. In an implementation, each of the matrices of the fixed dictionary

$$\{ {U}_{1} , … , {U}_{{2}^{{B}_{p}^{′}}} \}$$

may be the same unitary matrix (may also be represented as V) hence, the fixed dictionary

$$\{ {U}_{1} , … , {U}_{{2}^{{B}_{p}^{′}}} \} = \{ V , … , V \}$$

Therefore, in case of multiple transmitters, each transmitter uses the same unitary matrix (i.e., V). In another implementation, each of the matrices of the fixed dictionary

$$\{ {U}_{1} , … , {U}_{{2}^{{B}_{p}^{′}}} \}$$

may be the same unitary matrix (i.e., V) multiplied by the same permutation matrix (may also be represented as Π) hence, the fixed dictionary

$$\{ {U}_{1} , … , {U}_{{2}^{{B}_{p}^{′}}} \} = \{ V Π , … , V Π \} .$$

In a yet another implementation, each of the matrices of the fixed dictionary

$$\{ {U}_{1} , … , {U}_{{2}^{{B}_{p}^{′}}} \}$$

may be the same unitary matrix (i.e., V) multiplied by the truncated permutation matrices (may also be represented as Πᵢ) that are disjoint, which means

$${Π}_{i} {Π}_{j}^{T} = 0 for any i \neq j .$$

Therefor, the fixed dictionary

$$\{ {U}_{1} , … , {U}_{{2}^{{B}_{p}^{′}}} \} = \{ V {Π}_{1} , … , V {Π}_{1} , V {Π}_{2} , … , V {Π}_{2} , … , V {Π}_{n} , … , V {Π}_{n} \} .$$

In a yet another implementation, each of the matrices of the fixed dictionary

$$\{ {U}_{1} , … , {U}_{{2}^{{B}_{p}^{′}}} \}$$

may be the same unitary matrix (i.e., V) multiplied by the truncated permutation matrices (i.e., Πᵢ) that are not disjoint hence, the fixed dictionary

$$\{ {U}_{1} , … , {U}_{{2}^{{B}_{p}^{′}}} \} = \{ V {Π}_{1} , … , V {Π}_{1} , V {Π}_{2} , … , V {Π}_{2} , … , V {Π}_{n} , … , V {Π}_{n} \} .$$

In a yet another implementation, each of the matrices of the fixed dictionary

$$\{ {U}_{1} , … , {U}_{{2}^{{B}_{p}^{′}}} \}$$

may be the matrix from the set of matrices corresponding to subspaces of the Grassmannian space. Each matrix may have a dimension q in the space of dimension (T−p). In a yet another implementation, each of the matrices of the fixed dictionary

$$\{ {U}_{1} , … , {U}_{{2}^{{B}_{p}^{′}}} \}$$

may be the matrix from the set of truncated unitary matrices. Examples of the set of truncated unitary matrices may include but are not limited to, composition of Givens rotations, Fourier matrices, normalized Hadamard matrices, matrices concatenating Gabor frames, and the like.

The concatenation circuit 210 is configured to concatenate the first symbol vector and the second symbol vector into a baseband symbol vector. The concatenation circuit 210 is configured to multiply the first symbol vector (i.e., x₁⊗ . . . ⊗x_{d}) and the second symbol vector (i.e., Ua) in order to generate the baseband symbol vector (may also be represented as v) according to the equation (1). The baseband symbol vector (i.e., v) may also be referred to as a transmitted symbol vector.

$$v = ( \begin{matrix}{x}_{1} ⊗ … ⊗ {x}_{d} \\ Ua\end{matrix} ) \qquad ( 1 )$$

The modulation circuit 211 is configured to modulate the baseband symbol vector to generate a modulated symbol vector comprising modulated symbols.

The antenna 212 is configured to transmit each modulated symbol of the modulated symbol vector in a radio frequency signal to the receiving device 104. The radio frequency signal refers to an electromagnetic wave used to transmit each modulated symbol of the modulated symbol vector (i.e., v) over the air. Each modulated symbol of the modulated symbol vector (i.e., v) is linearly mapped to a corresponding signal frequency in order to modulate the modulated symbol vector in the radio frequency signal (e.g., a carrier wave), which is transmitted to the receiving device 104 (of FIG. 1).

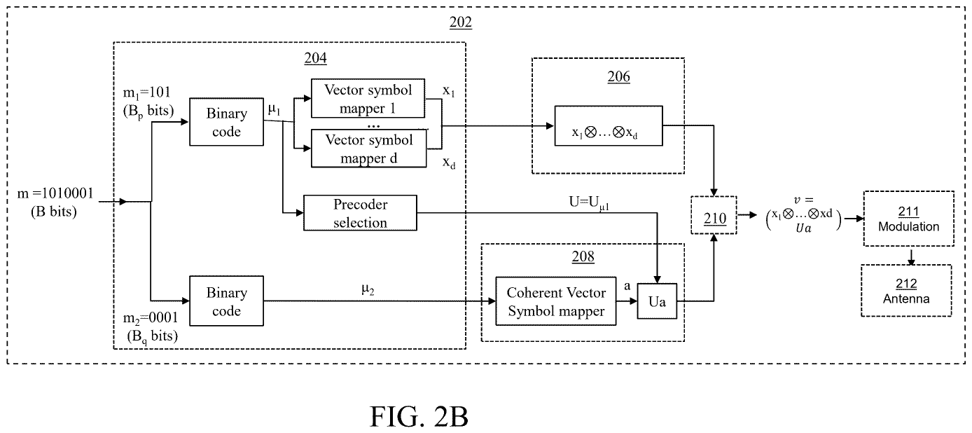

In accordance with an embodiment, the modulation circuit 211 is further configured to map the baseband symbol vector in a time-frequency grid associated with a plurality of time-frequency resources according to a pre-defined allocation matrix. In an implementation of the system 100, there might be no block fading channel between the transmitting device 202 and the receiving device 104. Alternatively stated, the transmitting device 202 (or the plurality of transmitting devices 102) and the receiving device 104 may not perfectly synchronized with each other and therefore, timing and carrier frequency offsets incur during data transmission from the transmitting device 202 to the receiving device 104 and are compensated at the receiving device 104. In such implementation, the time-frequency mapping is performed at the transmitting device 202 and the corresponding time-frequency de-mapping is also performed at the receiving device 104 along with the time and carrier frequency offsets estimation and compensation. The modulation circuit 211 is configured to map the baseband symbol vector in the time-frequency grid of an OFDM modulation with F frequency subcarriers and S time symbols, described in detail, for example, in FIG. 3. At each transmitting device (e.g., the transmitting device 202), the frequency-domain signal representation of each element of the mapped first symbol vector with N subcarriers undergo an inverse discrete Fourier transform (IDFT) to form N time-domain samples. Furthermore, in order to avoid any inter-symbol interference, a cyclic prefix (CP) of length N_{CP} samples, is added to each OFDM symbol (i.e., the N time-domain samples) at the transmitting device 202 through a “cyclic prefix” module. The resulting signal is then converter to an analog domain using a digital-to-analog converter and further upconverted to radio frequencies and amplified by use of an up-conversion and power amplification module, not shown here for sake of brevity.

In accordance with an embodiment, the first mapping circuit 206 is further configured to multiply each of the d vectors by a unitary matrix, prior to computing the Kronecker product. In an implementation, the first mapping circuit 206 is configured to multiply each of the d vectors (i.e., x_{1,k}, . . . , x_{d,k}) by the unitary matrix prior to computation of the Kronecker product. The unitary matrix provides an additional degree of freedom in the design of sub-constellation. In particular, using the structured sub-constellation together with the unitary matrix enables a low-complexity at the receiving device 104 along with an improved performance with respect to timing and carrier frequency offsets estimation and compensation.

In accordance with an embodiment, the concatenation circuit 210 is further configured to multiply the result of the concatenation of the first symbol vector and the second symbol vector by a permutation matrix to form the baseband symbol vector. The concatenation circuit 210 is configured to multiply the result of the concatenation of the first symbol vector (i.e., x₁⊗ . . . ⊗x_{d}) and the second symbol vector (i.e., Ua) by the permutation matrix to form the baseband symbol vector (i.e., v). In a case, the concatenation circuit 210 is configured to map the baseband symbol vector (i.e., v) in the time-frequency grid by parameterizing the baseband symbol vector (i.e., v) by the pre-defined permutation matrix (i.e., A∈ [symbol] ^{SF×SF}) according to the equation (2)

$${v}_{k} = A ( \begin{matrix}{x}_{1 , k} ⊗ … ⊗ {x}_{d , k} \\ {U}_{{μ}_{k}} {a}_{k}\end{matrix} ) ∈ {ℂ}^{SF} \qquad ( 2 )$$

The pre-defined permutation matrix (i.e., A) can be seen as a way to map the modulated symbol vector

$$( \begin{matrix}{x}_{1 , k} ⊗ … ⊗ {x}_{d , k} \\ {U}_{{μ}_{k}} {a}_{k}\end{matrix} )$$

on the time-frequency grid.

Thus, the transmitting device 202 provides an improved communication reliability and supports a large number of users simultaneously. Moreover, the transmitting device 202 combines the tensor-based modulation (TBM) with the coherent modulation and hence, manifests an improved spectral efficiency over the conventional tensor-based modulation in case of large bandwidth. Alternatively stated, the transmitting device 202 transmits a part of information payload by use of tensor-based modulation and transmits rest of the information payload by use of coherent modulation. Additionally, the transmitting device 202 may be used in a block fading channel as well as in a non-block fading channel. Since, the concatenation circuit 210 and the modulation circuit 211 of the transmitting device 202 includes time frequency mapping between elements of the first symbol vector and the used physical resources, which further enables an accurate estimation and compensation of timing and carrier frequency offsets at the receiving device 104 in the non-block fading channel and hence, the improved communication reliability is obtained in the communication system comprising the transmitting device 202 and the receiving device 104. Additionally, the transmitting device 202 enables an improved waveform design for the massive random-access communication with reduced probability of decoding error and an enhanced spectral efficiency.

FIG. 2C is a block diagram that illustrates various exemplary components of a transmitting device, in accordance with yet another embodiment of the present disclosure. FIG. 2C is described in conjunction with elements from FIGS. 1, 2A and 2B. With reference to FIG. 2C, there is shown a block diagram of the transmitting device 202.

The block diagram of the transmitting device 202 corresponds to the block diagram of the transmitting device 202 (of FIG. 2B) except that the encoding circuit 204 is configured to directly apply a binary code on the input message (i.e., the binary message, m=1010001) and output a main sequence of bits (may also be represented as u) without splitting the input message (i.e., binary message, m=1010001) into the first message (i.e., m₁=101) and the second message (i.e., m₂=0001) and then encode the first message and the second message, respectively.

In accordance with an embodiment, the encoding circuit 204 is configured to encode the input message into a main sequence of bits, and split the main sequence of bits into the first sequence of bits and the second sequence of bits. In the block diagram of the transmitting device 202, it is shown that the encoding circuit 204 is configured to directly encode the input message (i.e., binary message, m=1010001) into the main sequence of bits (i.e., μ) by use of the binary code. Furthermore, the encoding circuit 204 is configured to split the main sequence of bits (i.e., μ) into the first sequence of bits (i.e., μ₁) and the second sequence of bits (i.e., μ₂).

FIG. 3 is an illustration of time-frequency mapping of a modulated symbol vector in a time-frequency grid, in accordance with an embodiment of the present disclosure. FIG. 3 is described in conjunction with elements from FIGS. 1, 2A, 2B, and 2C. With reference to FIG. 3, there is shown a time-frequency grid 300 that represents a plurality of time-frequency resources. The time-frequency grid 300 includes an X-axis 302 and a Y-axis 304. The X-axis 302 represents time-domain representation and the Y-axis 304 represents frequency-domain representation.

The modulation circuit 211 of the transmitting device 202 is configured to map the baseband symbol vector (i.e., vₖ) in the time-frequency grid 300 of an OFDM modulation with F frequency subcarriers and S time symbols. The plurality of time-frequency resources of the time-frequency grid 300 are defined according to the pre-defined allocation matrix, where each element of the baseband symbol vector (i.e., vₖ) is mapped onto one of the time-frequency resources of the time-frequency grid 300. For example, a complex value (i.e., vₖ(s, f) corresponds to an element of the baseband symbol vector (i.e., vₖ) which is transmitted at a s-th time resource and a f-th frequency resource. Therefore, the baseband symbol vector (i.e., vₖ) may also be referred to as a SF dimensional vector. To be consistent with the vectorization operation related to the tensor structure, the SF dimensional vector may be represented as a column-first order vectorization of the time-frequency matrix as depicted by the equation (3).

$${v}_{k} = ( \begin{matrix}{v}_{k} ( 1 , 1 ) \\ {v}_{k} ( 1 , 2 ) \\ ⋮ \\ {v}_{k} ( S , F )\end{matrix} ) \qquad ( 3 )$$

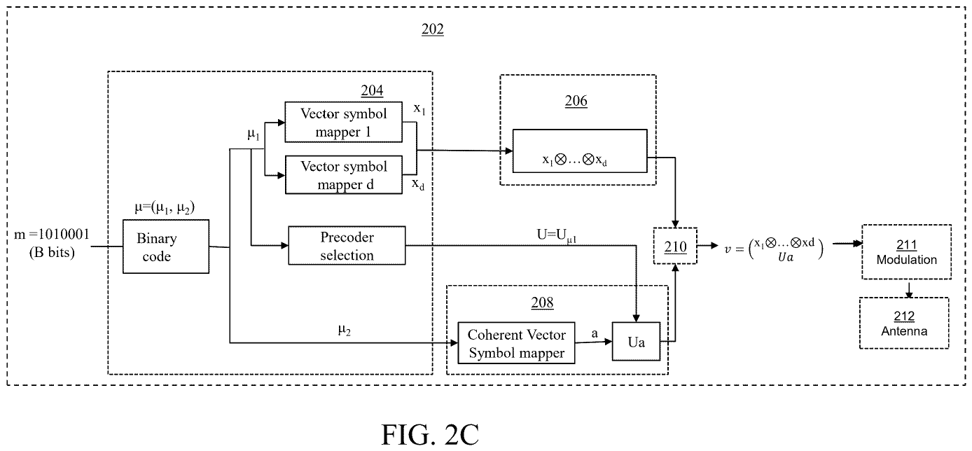

FIG. 4 is a flowchart of a method for a random-access communication, in accordance with an embodiment of the present disclosure. FIG. 4 is described in conjunction with elements from FIGS. 1, 2A, 2B, 2C, and 3. With reference to FIG. 4, there is shown a method 400 that includes steps 402 to 418. The method 400 is executed by each of the plurality of transmitting devices 102 (of FIG. 1) or by the transmitting device 202 (of FIG. 2).

The method 400 is provided for random-access communication in which a random number of the plurality of transmitting devices 102 (or the transmitting device 202) may be active at a time and may be configured to transmit a plurality of radio frequency signals concurrently to the receiving device 104 without any prior resource request (or grant). Moreover, the method 400 is applicable in two implementation scenarios, first is where there is a block fading channel between each of the plurality of transmitting devices 102 (or the transmitting device 202) and the receiving device 104, and second is where there is not a block fading channel between each of the plurality of transmitting devices 102 (or the transmitting device 202) and the receiving device 104. In the first implementation scenario, each of the plurality of transmitting devices 102 (or the transmitting device 202) and the receiving device 104 are in perfect synchronization with each other and hence, no timing and carrier frequency offsets occur in a system (e.g., the system 100, of FIG. 1). In the second implementation scenario, each of the plurality of transmitting devices 102 (or the transmitting device 202) and the receiving device 104 are not in perfect synchronization with each other and hence, timing and carrier frequency offsets incur during transmission from each of the plurality of transmitting devices 102 (or the transmitting device 202) to the receiving device 104 and are compensated at the receiving device 104.

At step 402, the method 400 comprises acquiring, by the encoding circuit 204 of the transmitting device 202, an input message. In an implementation, the input message corresponds to a binary message comprising a certain number of bits.

At step 404, the method 400 further comprises encoding, by the encoding circuit 204, the input message into a first sequence of bits and a second sequence of bits. The input message acquired by the encoding circuit 204 is further encoded into the first sequence of bits and the second sequence of bits either by use of a binary encoder or a polar encoder, and the like.

In accordance with an embodiment, encoding, by the encoding circuit 204, comprises splitting the input message into a first message and a second message, encoding the first message into the first sequence of bits, and encoding the second message into the second sequence of bits. In an implementation, the encoding circuit 204 is configured to split the input message into the first message and the second message and thereafter, encode the first message into the first sequence of bits and the second message into the second sequence of bits, respectively, described in detail, for example, in FIG. 2B.

In accordance with an embodiment, encoding, by the encoding circuit 204, comprises encoding the input message into a main sequence of bits, and splitting the main sequence of bits into the first sequence of bits and the second sequence of bits. In another implementation, the encoding circuit 204 is configured to encode the input message into the main sequence of bits and split the main sequence of bits into the first sequence of bits and the second sequence of bits, described in detail, for example, in FIG. 2C.

In accordance with an embodiment, encoding, by the encoding circuit 204, uses a binary code. The encoding circuit 204 is configured to encode the input message using the binary code, such as excess-3 codes, Gray codes, reflective codes, sequential codes, and the like.

At step 406, the method 400 further comprises splitting, by the encoding circuit 204, the first sequence of bits in d blocks of bits, where d>1. The first sequence of bits is split into d block of bits, where d is an arbitrary number and greater than 1.

At step 408, the method 400 further comprises determining, by the encoding circuit 204, d vectors based on the d blocks of bits. The d block of bits are further encoded into the d vectors based on the number of bits in each block of the d blocks.

At step 410, the method 400 further comprises constructing a first symbol vector, by the first mapping circuit 206 of the transmitting device 202, by computing a Kronecker product of the d vectors to generate a rank-1 tensor structure of order d. The first mapping circuit 206 is configured to construct the first symbol vector by computing the Kronecker product of the d vectors obtained from the d block of bits in order to generate the rank-1 tensor structure of order d. The constructed first symbol vector may also be referred to as the rank-1 tensor structure of order d which means that the constructed first symbol vector may be construed as a d-dimensional array of real and complex numbers.

At step 412, the method 400 further comprises mapping, by the second mapping circuit 208 of the transmitting device 202, the second sequence of bits to a vector of baseband symbols. The second mapping circuit 208 is configured to map the second sequence of bits to the vector of baseband symbols of dimensions q using a coherent modulation.

In accordance with an embodiment, mapping, by the second mapping circuit 208, the second sequence of bits to the vector of baseband symbols comprises using a quadrature amplitude modulation or a phase shift keying modulation. In an implementation, the second mapping circuit 208 may be configured to map the second sequence of bits to the vector of baseband symbols by using the quadrature amplitude modulation (QAM). Alternatively stated, each scalar element of the vector of baseband symbols is generated using the QAM symbol. In another implementation, the second mapping circuit 208 may be configured to map the second sequence of bits to the vector of baseband symbols by using the phase shift keying (PSK) modulation. Alternatively stated, each scalar element of the vector of baseband symbols is generated using the PSK symbol.

At step 414, the method 400 further comprises applying, by the second mapping circuit 208, an allocation matrix to the vector of baseband symbols to generate a second symbol vector, where the allocation matrix is a precoding matrix based on the first sequence of bits. The second mapping circuit 208 is configured to apply the allocation matrix to the vector of baseband symbols to generate the second symbol vector. The allocation matrix is also referred to as the precoding matrix that is determined on the basis of the first sequence of bits using a precoder selection.

In accordance with an embodiment, encoding, by the encoding circuit 204, comprises selecting the precoding matrix from a fixed dictionary comprising matrices, where each of the matrices of the fixed dictionary is equal to one of a same unitary matrix, a same unitary matrix multiplied by a same permutation matrix, a same unitary matrix multiplied by one truncated permutation matrix from a set of non-disjoint truncated permutation matrices, a matrix from a set of matrices corresponding to subspaces of a Grassmannian space, or a matrix from a set of truncated unitary matrices. The encoding circuit 204 is configured to select the precoding matrix from the fixed dictionary where, the fixed dictionary comprises a number of matrices. In an implementation, each of the matrices of the fixed dictionary may be the same unitary matrix. In another implementation, each of the matrices of the fixed dictionary may be the same unitary matrix multiplied by the same permutation matrix. In a yet another implementation, each of the matrices of the fixed dictionary may be the same unitary matrix multiplied by the truncated permutation matrices that are disjoint. In a yet another implementation, each of the matrices of the fixed dictionary may be the same unitary matrix multiplied by the truncated permutation matrices that are not disjoint. In a yet another implementation, each of the matrices of the fixed dictionary may be the matrix from the set of matrices corresponding to subspaces of the Grassmannian space. In a yet another implementation, each of the matrices of the fixed dictionary may be the matrix from the set of truncated unitary matrices.

At step 416, the method 400 further comprises concatenating, by the concatenation circuit 210 of the transmitting device 202, the first symbol vector and the second symbol vector into a baseband symbol vector. The concatenation circuit 210 is configured to concatenate the first symbol vector and the second symbol vector in order to generate the baseband symbol vector.

At step 417, the method 400 further comprises modulating, by the modulation circuit 211 of the transmitting device 202, the baseband symbol vector to generate a modulated symbol vector comprising modulated symbols.

At step 418, the method 400 further comprises transmitting, by the antenna 212 of the transmitting device 202, each modulated symbol of the modulated symbol vector in a radio frequency signal to the receiving device 104. The radio frequency signal refers to an electromagnetic wave used to transmit each modulated symbol of the modulated symbol vector (i.e., v) over the air. Each modulated symbol of the modulated symbol vector (i.e., v) is linearly mapped to a corresponding signal frequency in order to modulate the modulated symbol vector in the radio frequency signal (e.g., a carrier wave), which is transmitted to the receiving device 104 (of FIG. 1).

In accordance with an embodiment, constructing the modulated symbol vector, by the modulation circuit 211, further comprises mapping the baseband symbol vector in a time-frequency grid associated with a plurality of time-frequency resources according to a pre-defined allocation matrix. In case of imperfect synchronization between each of the plurality of transmitting devices 102 (or the transmitting device 202) and the receiving device 104, the modulation circuit 211 is configured to map the baseband symbol vector into the time frequency grid associated with the plurality of time-frequency resource, in order to, combined with the concatenation circuit 210, accurately and efficiently estimate and compensate the timing and carrier frequency offsets at the receiving device 104 which occur due to the imperfect synchronization between each of the plurality of transmitting devices 102 (or the transmitting device 202) and the receiving device 104. The modulation circuit 211 is configured to map the baseband symbol vector in the time-frequency grid of an OFDM modulation with F frequency subcarriers and S time symbols, described in detail, for example, in FIG. 3.

In accordance with an embodiment, the method 400 further comprises multiplying, by the first mapping circuit 206, each of the d vectors by a unitary matrix, prior to computing the Kronecker product. In an implementation, the first mapping circuit 206 is configured to multiply each of the d vectors by the unitary matrix prior to computation of the Kronecker product.

In accordance with an embodiment, the method 400 further comprises multiplying, by the concatenation circuit 210, the result of the concatenation of the first symbol vector and the second symbol vector by a permutation matrix to form the baseband symbol vector. The concatenation circuit 210 is configured to multiply the result of the concatenation of the first symbol vector and the second symbol vector by the permutation matrix to form the baseband symbol vector. In a case, the concatenation circuit 210 is configured to multiply the baseband symbol vector by the pre-defined permutation matrix.

The steps 402 to 418 are only illustrative and other alternatives can also be provided where one or more steps are added, one or more steps are removed, or one or more steps are provided in a different sequence without departing from the scope of the claims herein.

In one aspect, a computer program product is provided performing the method 400 when executed by one or more processors (e.g., the processor 214 of the transmitting device 202) in a computer system. In another aspect, a computer system is provided comprising one or more processors (e.g., the processor 214) and one or more memories (e.g., the memory 216), the one or more memories (i.e., the memory 216) storing program instructions which, when executed by the one or more processors (i.e., the processor 214), cause the one or more processors (i.e., the processor 214) to execute the method 400. As previously mentioned, in an implementation, some or all of the one or more memories may be part of some or all of the one or more processors. In another implementation, all of the one or more memories are components separated from the one or more processors.

In another aspect, a processor is provided comprising the various circuits configured to execute the method 400, such as the encoding circuit 204, the first mapping circuit 206, the second mapping circuit 208, the concatenation circuit 210, and the modulation circuit 211.

In yet another aspect, the present disclosure provides a non-transitory computer-readable medium having stored thereon, computer-implemented instructions that, when executed by a computer, causes the computer to execute operations of the method 400.

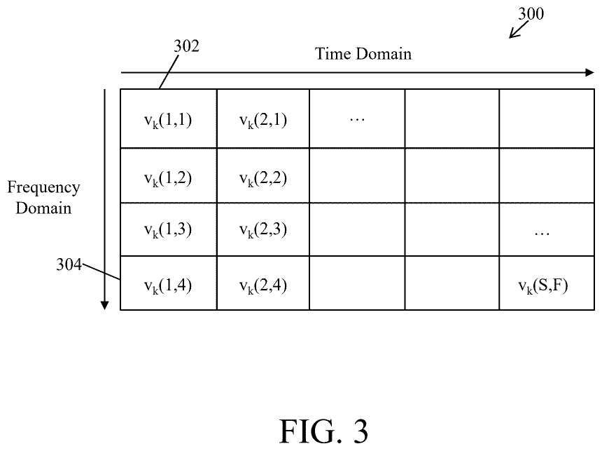

FIG. 5 is a block diagram that illustrates various exemplary components of a receiving device, in accordance with an embodiment of the present disclosure. FIG. 5 is described in conjunction with elements from FIGS. 1, and 2. With reference to FIG. 5, there is shown a block diagram 500 of the receiving device 104 (of FIG. 1) that includes an antenna 502, a demodulation circuit 503, a splitting circuit 504, a separation circuit 506, an equalizing circuit 508, a decoding circuit 510, a processor 512 and a memory 514. The decoding circuit 510 comprises a plurality of first decoders 516, a plurality of second decoders 518 and a plurality of decoders 520. In an implementation, each of the demodulation circuit 503, the splitting circuit 504, the separation circuit 506, the equalizing circuit 508, and the decoding circuit 510 may be a part of the processor 512. In another implementation, the demodulation circuit 503, the splitting circuit 504, the separation circuit 506, the equalizing circuit 508, and the decoding circuit 510 are separate circuits or modules (and may not be a part of the processor 512). The demodulation circuit 503, the splitting circuit 504, the separation circuit 506, the equalizing circuit 508, and the decoding circuit 510 are communicatively coupled to the memory 514 and the antenna 502. The receiving device 104 includes at least one antenna, such as the antenna 502 (or 1, 2, 3 . . . , M number of antennas).

The antenna 502 may include suitable logic, circuitry, and/or interfaces that is configured to receive a plurality of radio frequency signals concurrently from a plurality of transmitting devices, such as the plurality of transmitting devices 102 (of FIG. 1). Beneficially, the number of receiving antennas at the receiving device 104 is potentially less than number of transmitting signals. Examples of implementation of the antenna 502 is similar to that of the antenna 212 (FIG. 2A).

The demodulation circuit 503 may include suitable logic, circuitry, and/or interfaces that is configured to demodulate the received radio frequency signals into demodulated signals.

The splitting circuit 504 may include suitable logic, circuitry, and/or interfaces that is configured to split the demodulated signals into first baseband signals and second baseband signals.

The separation circuit 506 may include suitable logic, circuitry, and/or interfaces that is configured to generate a plurality of first estimated symbol vectors from the first baseband signals, using a rank-1 tensor structure of order d associated with each transmitting device, where d>1, and to generate a plurality of estimated channel parameters associated with the plurality of transmitting devices 102 and a plurality of estimated precoding matrices associated with the plurality of transmitting devices 102, based on the first baseband signals.

The equalizing circuit 508 may include suitable logic, circuitry, and/or interfaces that is configured to estimate a plurality of second estimated symbol vectors from the second baseband signals, based on the plurality of estimated precoding matrices and the plurality of estimated channel parameters.

The decoding circuit 510 may include suitable logic, circuitry, and/or interfaces that is configured to decode each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices (102).

The processor 512 may include suitable logic, circuitry, and/or interfaces that is configured to execute instructions stored in the memory 514. Examples of implementation of the processor 512 is similar to that of the processor 214 (of FIG. 2A).

The memory 514 may include suitable logic, circuitry, and/or interfaces that is configured to store machine code and/or instructions executable by the processor 512. The memory 514 may temporally store one or more decoded messages. Examples of implementation of the memory 514 is similar to that of the memory 216 (of FIG. 2A). The memory 514 may store an operating system and/or a computer program product to operate the receiving device 104. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

In operation, the receiving device 104 used for random access communication, comprises the antenna 502 that is configured to receive a plurality of radio frequency signals concurrently from the plurality of transmitting devices 102. In a massive random-access scenario, the antenna 502 of the receiving device 104 is configured to receive the plurality of radio frequency signals concurrently from the plurality of transmitting devices, such as the plurality of transmitting devices 102 (of FIG. 1), over M antennas and T channel accesses.

The receiving device 104 further comprises the demodulation circuit 503 that is configured to demodulate the received radio frequency signals into demodulated signals.

The receiving device 104 further comprises the splitting circuit 504 that is configured to split the demodulated signals into first baseband signals and second baseband signals. In case of the perfect synchronization between each of the plurality of transmitting devices 102 and the receiving device 104, the splitting circuit 504 of the receiving device 104 is configured to split the plurality of demodulated signals into the first baseband signals (or a first pM-dimensional vector, yₚ) and the second baseband signals (or a second (T−p)M-dimensional vector, y_{q}). In this way, the plurality of demodulated signals received concurrently from the plurality of transmitting devices 102 in form of the first baseband signals (i.e., yₚ) and the second baseband signals (i.e., y_{q}) may be represented according to the equation (4)

$$y = ( \begin{matrix}{y}_{p} \\ {y}_{q}\end{matrix} ) = {\sum }_{k = 1}^{K} {v}_{k} ⊗ {h}_{k} + w = ( \begin{matrix}{\sum }_{k = 1}^{K} {x}_{1 , k} ⊗ … ⊗ {x}_{d , k} ⊗ {h}_{k} \\ {\sum }_{k = 1}^{K} {U}_{{μ}_{1 , k}} {a}_{k} ⊗ {h}_{k}\end{matrix} ) + ( \begin{matrix}{w}_{p} \\ {w}_{q}\end{matrix} ) \qquad ( 4 )$$

The vector wₚ and w_{q} correspond to noise terms received with the first basebandsignals (i.e., yₚ) and the second basebandsignals (i.e., y_{q}), respectively.

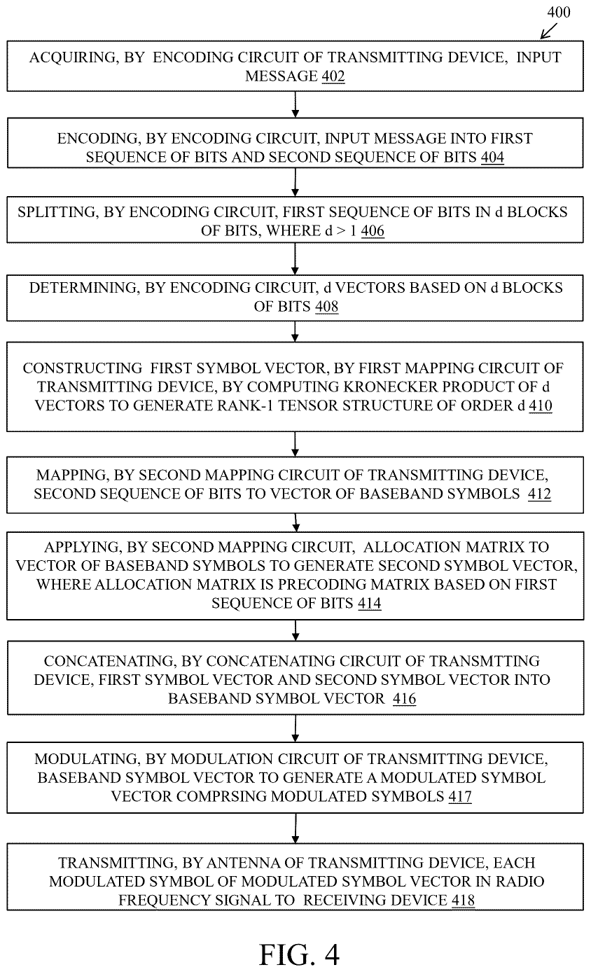

The receiving device 104 further comprises the separation circuit 506 that is configured to generate a plurality of first estimated symbol vectors from the first baseband signals, using a rank-1 tensor structure of order d associated with each transmitting device, where d>1, and generate a plurality of estimated channel parameters associated with the plurality of transmitting devices 102 and a plurality of estimated precoding matrices associated with the plurality of transmitting devices 102, based on the first baseband signals. The separation circuit 506 is configured to generate a plurality of first estimated symbol vectors from the first baseband signals which are transmitted over p grid resource elements, using the rank-1 tensor structure of order d associated with each transmitting device, where d>1, this may also be referred to as a tensor decomposition. The separation circuit 506 is further configured to generate the plurality of estimated channel parameters associated with the plurality of transmitting devices 102 and the plurality of estimated precoding matrices associated with the plurality of transmitting devices 102, based on the first baseband signals, described in detail, for example, in FIGS. 6, 7 and 9.

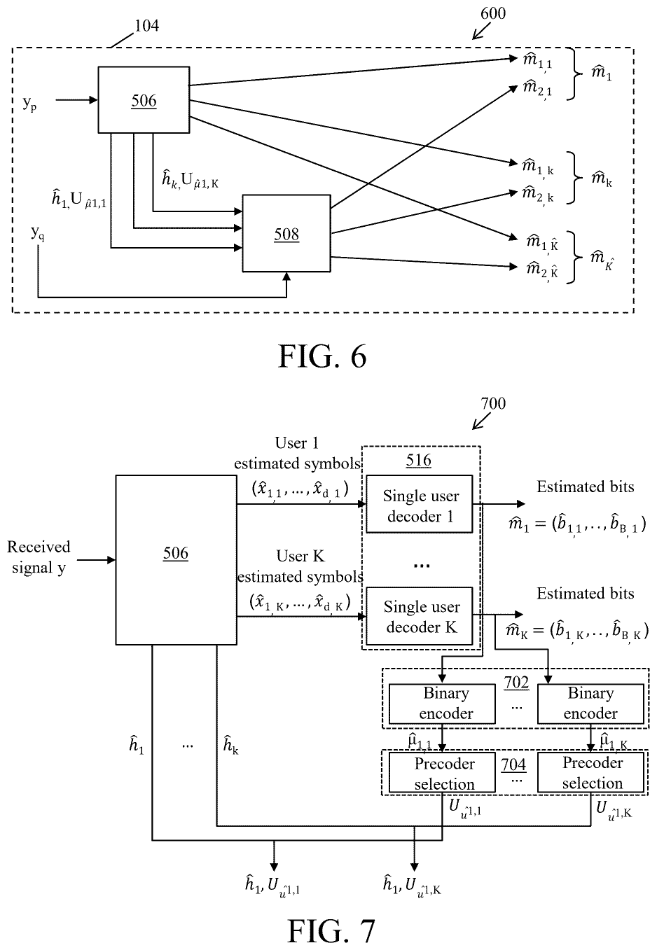

The receiving device 104 further comprises the equalizing circuit 508 that is configured to generate a plurality of second estimated symbol vectors from the second baseband signals, based on the plurality of estimated precoding matrices and the plurality of estimated channel parameters. The equalizing circuit 508 is configured to generate the plurality of second estimated symbol vectors from the second baseband signals which are transmitted over the resource elements occupied by the coherent modulation, based on the plurality of estimated precoding matrices and the plurality of estimated channel parameters computed by using the first radio frequency signals, described in detail, for example, in FIG. 8.

The receiving device 104 further comprises the decoding circuit 510 that is configured to decode each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices 102.

The decoding circuit 510 is configured to decode each of the first estimated symbol vectors to generate the plurality of first decoded messages (may also be represented as \hat{m}_{1,1}, . . . , \hat{m}_{1,k}, . . . , \hat{m}_{1,\hat{K}}). Each of the plurality of first decoded messages, for example, a first decoded message (may also be represented as \hat{m}_{1,1}) comprises the first sequence of bits (may also be represented as \hat{m}_{1,1}=\hat{b}_{1,1}, . . . , \hat{b}_{B,1}) that corresponds to the first part of data associated with the corresponding transmitting device (e.g., the first transmitting device 102A) of the plurality of transmitting devices 102.

The decoding circuit 510 is further configured to decode each of the second estimated symbol vectors to generate a plurality of second decoded messages, each of the second decoded messages comprising a second sequence of bits corresponding to a second part of data associated with a corresponding transmitting device amongst the plurality of transmitting devices 102. The decoding circuit 510 is configured to decode each of the second estimated symbol vectors to generate the plurality of second decoded messages (may also be represented as \hat{m}_{2,1}, . . . , \hat{m}_{2,k}, . . . , \hat{m}_{2,\hat{K}}). Each of the second decoded messages, for example, a second decoded message (may also be represented as \hat{m}_{2,1}) comprises the second sequence of bits (may also be represented as \hat{m}_{2,1}=\hat{b}_{1,2}, . . . , \hat{b}_{B,2}) that corresponds to the second part of data associated with the corresponding transmitting device (e.g., the first transmitting device 102A) amongst the plurality of transmitting devices 102.

In accordance with an embodiment, the splitting circuit 504 is further configured to apply a predefined permutation matrix to the demodulated signals to generate the first baseband signals and the second baseband signals. This predefined permutation corresponds to reverting the effect of the predefined permutation matrix (i.e., A) used at the transmitting device 202 (of FIG. 2) by applying the predefined permutation matrix (may also be represented as (A⊗I_{M})⁻¹) to each of the first and second baseband signals at the receiving device 104. After applying the pre-defined permutation matrix (i.e., (A⊗I_{M})⁻¹) to each of the first and second baseband signals, the plurality of first and second estimated symbol vectors is generated at the receiving device 104.

In accordance with an embodiment, the separation circuit 506 is further configured to estimate a time offset and a frequency offset in each of the first estimated symbol vectors to generate a plurality of time offsets and a plurality of frequency offsets, and apply a time offset compensation, based on the corresponding time offset, and a frequency offset compensation, based on the corresponding frequency offset, to the corresponding first estimated symbol vector. In a case, when there is no block fading channel between each of the plurality of transmitting devices 102 (or the transmitting device 202) and the receiving device 104, timing and carrier frequency offsets occur at each of the plurality of transmitting devices 102 and are compensated at the receiving device 104. Therefore, the separation circuit 506 is further configured to estimate as well as compensate the timing and carrier frequency offsets at the receiving device 104. Alternatively stated, the separation circuit 506 is configured to estimate the time offset and the carrier frequency offset in each of the first estimated symbol vectors, and apply the time offset compensation based on the corresponding time offset, and the frequency offset compensation, based on the corresponding frequency offset, to the corresponding estimated symbol vector.

Thus, the receiving device 104 provides an improved communication reliability and supports a large number of users simultaneously. Moreover, the receiving device 104 detects a set of active transmitting devices among the plurality of transmitting devices 102 as well as estimates the respective channels of the set of active transmitting devices among the plurality of transmitting devices 102 by virtue of the separation circuit 506, and the equalizing circuit 508. Moreover, the equalizing circuit 508 is configured to use the plurality of time offsets, the plurality of frequency offsets, the plurality of estimated precoding matrices and the plurality of estimated channel parameters to de-map the coherent modulation used at the transmitting device 202. Additionally, the receiving device 104 may be used in a block fading channel as well as in a non-block fading channel. By virtue of the time-frequency mapping of elements of the first symbol vector and rotation of each element of the first symbol vector by use of the unitary matrix used at the transmitting device 202 and the separation circuits 506, an accurate estimation and compensation of timing and carrier frequency offsets can be achieved which further leads to the reduced probability of decoding error and the improved communication reliability at the receiving device 104.

FIG. 6 is an illustration of a receiving device, in accordance with an embodiment of the present disclosure. FIG. 6 is described in conjunction with elements from FIGS. 1, 2A, 2B, 2C, 3, 4, and 5. With reference to FIG. 6, there is shown an illustration 600 of the receiving device 104 (of FIG. 1) that includes the separation circuit 506, and the equalizing circuit 508.

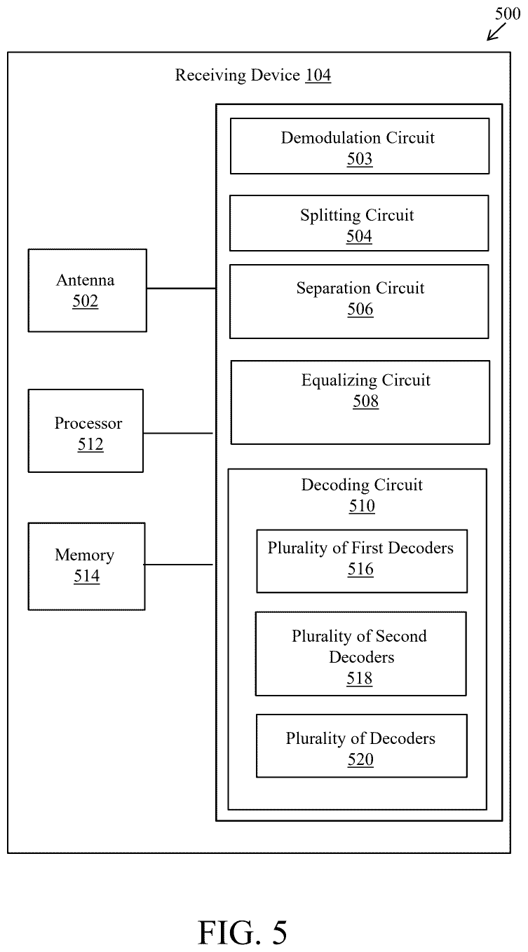

The first baseband signals (i.e., the first pM-dimensional vector, yₚ) is processed by the separation circuit 506. The separation circuit 506 may also be referred to as a tensor-based modulation (TBM) receiver. The separation circuit 506 is configured to generate a plurality of first sub-messages (may also be represented as \hat{m}_{1,1}, . . . , \hat{m}_{1,k}, . . . , \hat{m}_{1,\hat{K}}) with respect to each of the plurality of transmitting devices 102 as well as their associated plurality of estimated channel parameters (may also be represented as ĥ₁, . . . , ĥ_{K}), described in detail, for example, in FIG. 7. Furthermore, the separation circuit 506 is configured to generate the plurality of estimated precoding matrices (may also be represented as U_{\hat{μ}}_{_{1,1}} . . . , U_{\hat{μ}}_{_{1,K}}_{) associated with the plurality of transmitting devices 102, based on the first radio frequency signals. Alternatively stated, the separation circuit 506 is configured to generate a plurality of coded first sub-messages, for example, a coded first sub-message (may also be represented as \hat{μ}}_{1,k}) and its corresponding precoding matrix (may also be represented as U_{\hat{μ}}_{_{1,k}}). Moreover, the second basebandsignals (i.e., the second (T−p)M-dimensional vector, y_{q}) is processed by the equalizing circuit 508. The equalizing circuit 508 may also be referred to as a coherent receiver. The equalizing circuit 508 is configured to generate a plurality of second sub-messages (may also be represented as \hat{m}_{2,1}, . . . , \hat{m}_{2,k}, . . . , \hat{m}_{2,\hat{K}}) with respect to each of the plurality of transmitting devices 102 using the plurality of estimated precoding matrices (i.e., U_{\hat{μ}}_{_{1,1}}, . . . , U_{\hat{μ}}_{_{1,K}}) and the plurality of estimated channel parameters ĥ₁, . . . , ĥ_{K}, described in detail, for example, in FIG. 8. Thereafter, the plurality of second sub-messages (i.e., \hat{m}_{2,1}, . . . , \hat{m}_{2,k}, . . . , \hat{m}_{2,\hat{K}}) generated by the equalizing circuit 508 is concatenated with the plurality of first sub-messages (i.e., \hat{m}_{1,1}, . . . , \hat{m}_{1,k}, . . . , \hat{m}_{1,\hat{K}}) generated by the separation circuit 506 in order to form a plurality of estimated messages (may also be represented as \hat{m}ₖ) of the K-th transmitting device 102K of the plurality of transmitting devices 102.

FIG. 7 is an illustration of a separation circuit of a receiving device, in accordance with an embodiment of the present disclosure. FIG. 7 is described in conjunction with elements from FIGS. 1, 2A, 2B, 2C, 3, 4, 5, and 6. With reference to FIG. 7, there is shown an illustration 700 of the separation circuit 506 and the decoding circuit 510 of the receiving device 104 (of FIG. 1). There is further shown a plurality of binary encoders 702 and a plurality of precoder selection circuits 704.

By processing the received first baseband signals (i.e., the first pM-dimensional vector, yₚ), the separation circuit 506 is configured to generate the plurality of first estimated symbol vectors. Thereafter, the plurality of first estimated symbol vectors is subjected to a tensor decomposition (e.g., a canonical polyadic decomposition) corresponding to each of the plurality of transmitting devices 102. The tensor decomposition is used to separate the plurality of first estimated symbol vectors into single-user components, and hence, outputs an estimation of \hat{K} vector symbols \hat{v}ₖ for k=1, . . . , \hat{K}. The integer \hat{K} denotes the estimated number of transmitted messages. For example, a first estimated symbol vector (may also be represented as \hat{x}_{1,1} . . . , \hat{x}_{d,1}) corresponds to the first transmitting device 102A and a K-th estimated symbol vector (may also be represented as \hat{x}_{1,k} . . . , \hat{x}_{d,k}) corresponds to the K-th transmitting device 102K of the plurality of transmitting devices 102. Additionally, during the tensor decomposition, the separation circuit 506 is configured to generate the plurality of estimated channel parameters (i.e., ĥ₁, . . . , ĥ_{K}) associated with the plurality of transmitting devices 102.

In accordance with an embodiment, the decoding circuit 510 comprises the plurality of first decoders 516, each configured to decode one of the first estimated symbol vectors generated by the separation circuit 506 to generate a plurality of first decoded messages, each first decoded message comprising a first sequence of bits corresponding to a first part of data associated with a corresponding transmitting device amongst the plurality of transmitting devices 102. After processing the received first radio frequency signals (i.e., the first pM-dimensional vector, yₚ) into the plurality of first estimated symbol vectors, the plurality of first decoders 516 (or single-user decoders) of the decoding circuit 510 is configured to decode one of the first estimated symbol vectors to generate the plurality of first decoded messages (i.e., \hat{m}_{1,1}, . . . , \hat{m}_{1,k}, . . . , \hat{m}_{1,\hat{K}}). For example, the first estimated symbol vector (i.e., \hat{x}_{1,1} . . . , \hat{x}_{d,1}) corresponding to the first transmitting device 102A is used to generate a first decoded message (may also be represented as \hat{m}₁) of the plurality of first decoded messages. Similarly, the K-th estimated symbol vector (i.e., \hat{x}_{1,k} . . . , \hat{x}_{d,k}) corresponding to the K-th transmitting device 102K is used to generate a K-th decoded message (may also be represented as \hat{m}ₖ) of the plurality of first decoded messages. Each of the plurality of first decoded messages comprises the first sequence of bits corresponding to the first part of data associated with the corresponding transmitting device amongst the plurality of transmitting devices 102. For example, the first decoded message (i.e., \hat{m}₁) comprises the first sequence of bits (may also be represented as \hat{b}_{1,1}, . . . , \hat{b}_{B,1}) that corresponds to the first part of data associated with the corresponding transmitting device (e.g., the first transmitting device 102A) amongst the plurality of transmitting devices 102. Similarly, the K-th decoded message (i.e., \hat{m}ₖ) comprises the K-th sequence of bits (may also be represented as \hat{b}_{1,k}, . . . , \hat{b}_{B,k}) that corresponds to the first part of data associated with the corresponding transmitting device (e.g., the K-th transmitting device 102K) amongst the plurality of transmitting devices 102.

Thereafter, the plurality of first decoded messages (i.e., \hat{m}_{1,1}, . . . , \hat{m}_{1,k}, . . . , \hat{m}_{1,\hat{K}}) are subjected to the plurality of binary encoders 702 and the plurality of precoder selection circuits 704 to estimate the plurality of precoding matrices (i.e., U_{\hat{μ}}_{_{1,1}}, . . . , U_{\hat{μ}}_{_{1,K}}) associated with the plurality of transmitting devices 102.

FIG. 8 is an illustration of an equalizing circuit of a receiving device, in accordance with an embodiment of the present disclosure. FIG. 8 is described in conjunction with elements from FIGS. 1, 2A, 2B, 2C, 3, 4, 5, 6, and 7. With reference to FIG. 8, there is shown an illustration 800 of the equalizing circuit 508 and the decoding circuit 510 of the receiving device 104 (of FIG. 1). There is further shown a soft de-mapper 802.

The equalizing circuit 508 can be implemented using any classical coherent receiver (e.g., a minimum mean square error, MMSE equalizer). The equalizing circuit 508 of the receiving device 104 is configured to estimate a plurality of second estimated symbol vectors based on the second radio frequency signals (i.e., the second (T−p) M-dimensional vector, y_{q}) using a system of linear equations according to the equation (5)

$${y}_{q} = {\sum }_{k = 1}^{K} {U}_{{μ}_{1 , k}} {a}_{k} ⊗ {h}_{k} + {w}_{q} \qquad ( 5 )$$

An approximate solution of the equation (5) is obtained by replacing the hₖ by the plurality of estimated channel parameters (i.e., ĥₖ) and the precoding matrices U_{μ}_{_{1,k}} by the plurality of estimated precoding matrices (i.e., U_{\hat{μ}}_{_{1,k}}) in the equation (6), where both ĥₖ and \hat{μ}_{1,k} are estimated by the separation circuit 506 of the receiving device 104 (or the TBM receiver), and solving the equation (6) in order to estimate the plurality of second estimated symbol vectors by computing a minimum mean square error (MMSE).

$${y}_{q} = {\sum }_{k = 1}^{K} {U}_{{\hat{μ}}_{1 , k}} {a}_{k} ⊗ {\hat{h}}_{k} + {w}_{q} \qquad ( 6 )$$

After applying the equalizing circuit 508 on the second radio frequency signals (i.e., the second (T−p) M-dimensional vector, y_{g}), the soft de-mapper 802 is used in order to compute log-likelihood ratios (LLR) which represents the inferred values of the bits encoded in a₁ . . . a_{K}. The LLR computations (may also be represented as l_{1,1}, . . . , l_{1,B}, l_{k,1}, . . . , l_{k,B}, l_{K,1}, . . . , l_{K,B}) are then processed by the plurality of second decoders 518 (e.g., binary decoders) of the decoding circuit 510.

The decoding circuit 510 further comprises the plurality of second decoders 518, each configured to decode one of the second estimated symbol vectors generated by the equalization circuit 508 (or the MMSE equalizer) to generate a plurality of second decoded messages, each of the second decoded messages comprising a second sequence of bits corresponding to a second part of data associated with a corresponding transmitting device amongst the plurality of transmitting devices 102. For each of the generated plurality of second decoded messages (i.e., \hat{m}_{2,1}, . . . , \hat{m}_{2,k}), code validity is checked. The code validity can be checked, for example, if code redundancy checksum (CRC) bits are included in the binary code in which case the code is valid when the CRC constraints are satisfied. For the second decoded messages that do not satisfy the code validity, the process of checking the code validity is iterated for a predefined number of times. This may also be noted that the parameter q can be chosen freely, it influences the performance of the equalizing circuit 508 (i.e., MMSE equalizer). Indeed, a joint equalization approach can also be used that involves solving a system of (T−p)·M equations involving q·K unknown scalar variables in the form of a₁ . . . a_{K}. Thus, it may be advantageous to impose q·K≤(T−p)·M in order to ensure an adequate performance of the equalizing circuit 508 (or the MMSE equalizer). Similarly, the dictionary of linear precoders

$$( i . e . , \{ {U}_{1} , … , {U}_{{2}^{{B}_{p}^{′}}} \} )$$

shall be chosen in order to minimize the overlap between the linear subspaces spanned by K elements randomly selected from the dictionary of linear precoders

$$( i . e . , \{ {U}_{1} , … , {U}_{{2}^{{B}_{p}^{′}}} \} ) ,$$

in order to ensure that the equalizing circuit 508 (or the MMSE equalizer) generates a reliable output.

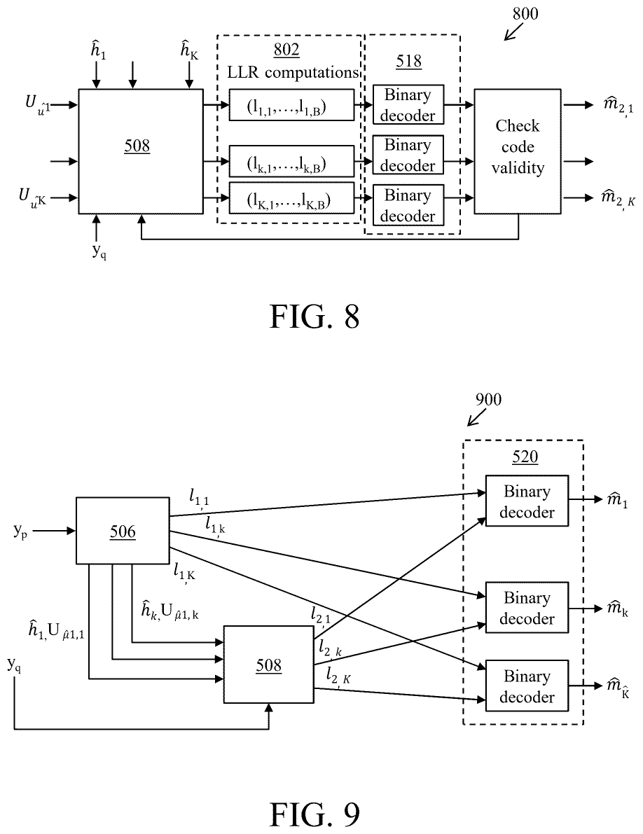

FIG. 9 is another illustration of a receiving device, in accordance with another embodiment of the present disclosure. FIG. 9 is described in conjunction with elements from FIGS. 1, 2A, 2B, 2C, 3, 4, 5, 6, 7, and 8. With reference to FIG. 9, there is shown an illustration 900 of the receiving device 104 (of FIG. 1) that includes the separation circuit 506, and the equalizing circuit 508 and the plurality of decoders 520 of the decoding circuit 510.

The illustration 900 of the receiving device 104 is an alternative version of the illustration 600 of the receiving device 104 (of FIG. 6). Moreover, the illustration 900 of the receiving device 104 may be used in correspondence with the transmitting device 202 (of FIG. 2C). In the illustration 900 of the receiving device 104, the separation circuit 506 (or the TBM receiver) and the equalizing circuit 508 (or the coherent receiver) do no perform the binary decoding. Moreover, each of the separation circuit 506 (or the TBM receiver) and the equalizing circuit 508 (or the coherent receiver) provides the output in form of “soft information” under the form of vectors of LLR (may also be represented as l_{1,k}, and l_{2,k} of respective size

$${B}_{p}^{′} and {B}_{q}^{′}$$

bits). The soft information is then concatenated for each transmitting device and taken as input to each of the plurality of decoders 520 (e.g., a binary decoder) of the decoding circuit 510, which is configured to perform the message decoding outputting the estimated messages.

In accordance with an embodiment, the decoding circuit 510 comprises the plurality of decoders 520, each configured to receive one of the first estimated symbol vectors and one of the second estimated symbol vectors, concatenate the received first and second estimated symbol vectors into a concatenated estimated symbol vector, and decode the concatenated estimated symbol vector to generate a plurality of decoded messages, each decoded message comprising a first sequence of bits and a second sequence of bits, the first sequence of bits corresponding to a first part of data associated with a corresponding transmitting device amongst the plurality of transmitting devices 102, and the second sequence of bits corresponding to a second part of data associated with the corresponding transmitting device. Alternatively stated, each of the plurality of decoders 520 of the decoding circuit 510 is configured to receive the soft information in terms of one of the first estimated symbol vectors (i.e., l_{1,1}, . . . , l_{1,k}, . . . , l_{1,K}) and one of the second estimated symbol vectors (i.e., l_{2,1}, . . . , l_{2,k}, . . . , l_{2,K}). Thereafter, each of the plurality of decoders 520 is configured to concatenate the received first and second estimated symbol vectors into the concatenated estimated symbol vector, and decode the concatenated estimated symbol vector to generate the plurality of decoded messages (i.e., \hat{m}₁, . . . , \hat{m}ₖ, . . . , \hat{m}_{\hat{K}}). Each decoded message comprises the first sequence of bits (i.e., \hat{b}_{1,1}, . . . , \hat{b}_{B,1}) and the second sequence of bits (i.e., \hat{b}_{1,2}, . . . , \hat{b}_{B,2}), the first sequence of bits corresponds to the first part of data associated with the corresponding transmitting device (e.g., the first transmitting device 102A) amongst the plurality of transmitting devices 102, and the second sequence of bits corresponds to the second part of data associated with the corresponding transmitting device (e.g., the first transmitting device 102A) amongst the plurality of transmitting devices 102.

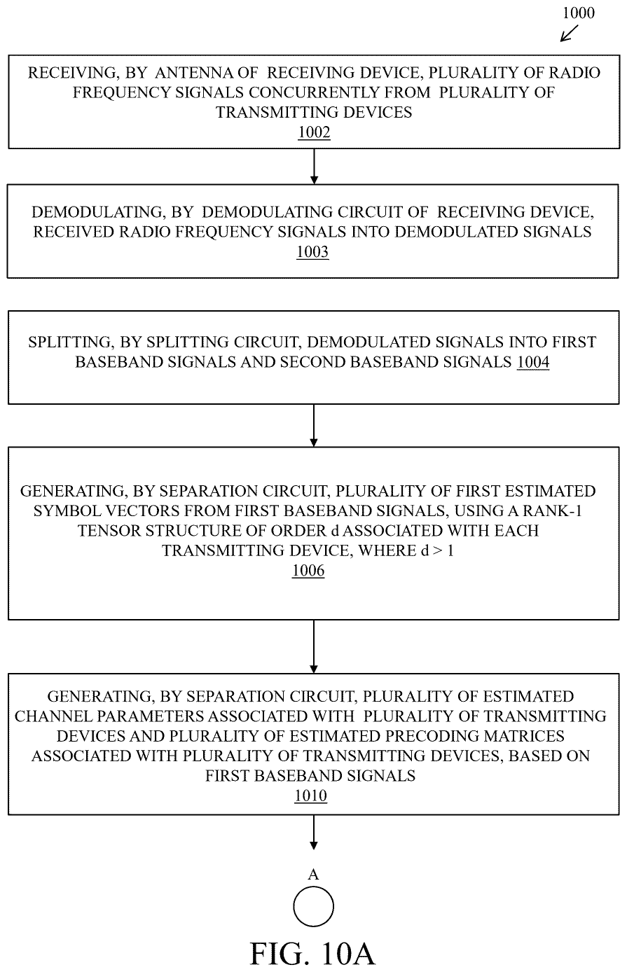

FIGS. 10A and 10B collectively is a flowchart of a method for random access communication, in accordance with an embodiment of the present disclosure. With reference to FIGS. 10A and 10B, there is shown a method 1000 for random access communication. The method 1000 includes steps 1002 to 1018 (steps 1002-1010 of the method 1000 are shown in FIG. 10A and steps 1012-1018 are shown in FIG. 10B). The method 1000 is executed by the receiving device 104 (of FIG. 1).

The method 1000 is provided for random-access communication in which a random number of the plurality of transmitting devices 102 (or the transmitting device 202) may be active randomly and may be configured to transmit a plurality of radio frequency signals concurrently to the receiving device 104 without any prior resource request (or grant). Moreover, the method 1000 is applicable in two implementation scenarios, first is where there is a block fading channel between each of the plurality of transmitting devices 102 (or the transmitting device 202) and the receiving device 104, and second is where there is not a block fading channel between each of the plurality of transmitting devices 102 (or the transmitting device 202) and the receiving device 104. In the first implementation scenario, each of the plurality of transmitting devices 102 (or the transmitting device 202) and the receiving device 104 are in perfect synchronization with each other and hence, no timing and carrier frequency offsets occur in a system (e.g., the system 100, of FIG. 1). In the second implementation scenario, each of the plurality of transmitting devices 102 (or the transmitting device 202) and the receiving device 104 are not in perfect synchronization with each other and hence, timing and carrier frequency offsets incur during transmission from each of the plurality of transmitting devices 102 (or the transmitting device 202) to the receiving device 104 and are compensated at the receiving device 104. By executing the method 1000, the receiving device 104 gets to know that how many transmitting devices are active at the transmitting side as well as estimate the respective channels of the active transmitting devices.

At step 1002, the method 1000 comprises receiving, by an antenna (e.g., the antenna 502) of a receiving device (e.g., the receiving device 104), a plurality of radio frequency signals concurrently from a plurality of transmitting devices (e.g., the plurality of transmitting devices 102). In a massive random-access scenario, the antenna 502 of the receiving device 104 is configured to receive the plurality of radio frequency signals concurrently from the plurality of transmitting devices 102 (of FIG. 1), over M antennas and T channel accesses.

At step 1003, the method 1000 comprises demodulating, by a demodulation circuit (e.g., the demodulation circuit 503) of a receiving device (e.g., the receiving device 104), the received radio frequency signals into demodulated signals.

At step 1004, the method 1000 further comprises splitting, by a splitting circuit (e.g., the splitting circuit 504) of a receiving device (e.g., the receiving device 104), the demodulated signals into first baseband signals and second basebandsignals. In case of the perfect synchronization between each of the plurality of transmitting devices 102 and the receiving device 104, the splitting circuit 504 of the receiving device 104 is configured to split the plurality of demodulated signals into the first basebandsignals and the second basebandsignals.

At step 1006, the method 1000 further comprises generating, by a separation circuit (e.g., the separation circuit 506) of a receiving device (e.g., the receiving device 104), a plurality of first estimated symbol vectors from the first baseband signals, using a rank-1 tensor structure of order d associated with each transmitting device, where d>1. The separation circuit 506 is configured to generate the plurality of first estimated symbol vectors from the first baseband signals which are transmitted over p grid resource elements. Furthermore, the separation circuit 506 is configured to separate the plurality of first estimated symbol vectors using the rank-1 tensor structure of order d (e.g., a canonical polyadic decomposition) associated with each transmitting device, where d>1, this may also be referred to as a tensor decomposition.

At step 1010, the method 1000 further comprises generating, by the separation circuit 506, a plurality of estimated channel parameters associated with the plurality of transmitting devices 102 and a plurality of estimated precoding matrices associated with the plurality of transmitting devices 102, based on the first baseband signals. The separation circuit 506 is further configured to generate the plurality of estimated channel parameters associated with the plurality of transmitting devices 102 and the plurality of estimated precoding matrices associated with the plurality of transmitting devices 102, based on the first baseband signals, described earlier in detail, for example, in FIGS. 6, 7, 8 and 9.

At step 1012, the method 1000 further comprises estimating, by an equalizing circuit (e.g., the equalizing circuit 508), a plurality of second estimated symbol vectors from the second baseband signals, which are transmitted over the resource elements occupied by the coherent modulation, based on the plurality of estimated precoding matrices and the plurality of estimated channel parameters. The equalizing circuit 508 is further configured to separate the plurality of second estimated symbol vectors, based on the plurality of estimated precoding matrices and the plurality of estimated channel parameters computed by using the first radio frequency signals, described earlier in detail, for example, in FIG. 8.

At step 1016, the method 1000 further comprises decoding, by a decoding circuit (e.g., the decoding circuit 510), each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices 102. The decoding circuit 510 is configured to decode each of the first and second estimated symbol vectors to generate the plurality of decoded messages. Each decoded message comprising a first sequence of bits that corresponds to a first part of data and a second sequence of bits that corresponds to a second part of data associated with a corresponding transmitting device amongst the plurality of transmitting devices 102.

In accordance with an embodiment, decoding, by the decoding circuit 510, comprises decoding, by each first decoder of a plurality of first decoders (e.g., the plurality of first decoders 516) of the decoding circuit 510, one of the first estimated symbol vectors to generate a plurality of first decoded messages, each first decoded messages comprising a first sequence of bits corresponding to a first part of data associated with a corresponding transmitting device amongst the plurality of transmitting devices 102. After processing the received first radio frequency signals into the plurality of first estimated symbol vectors, the plurality of first decoders 516 (or single-user decoders) of the decoding circuit 510 is configured to decode one of the first estimated symbol vectors to generate the plurality of first decoded messages. Each of the plurality of first decoded messages comprises the first sequence of bits corresponding to the first part of data associated with the corresponding transmitting device amongst the plurality of transmitting devices 102, described earlier in detail, for example, in FIG. 7.

The method 1000 further comprises decoding, by each second decoder of a plurality of second decoders (e.g., the plurality of second decoders 518) of the decoding circuit 510, one of the second estimated symbol vectors generated by the equalization circuit 508 to generate a plurality of second decoded messages, each of the second decoded messages comprising a second sequence of bits that corresponds to a second part of data associated with a corresponding transmitting device amongst the plurality of transmitting devices 102. After processing the received second radio frequency signals into the plurality of second estimated symbol vectors, the plurality of second decoders 518 (or single-user decoders) of the decoding circuit 510 is configured to decode one of the second estimated symbol vectors to generate the plurality of second decoded messages. Each of the plurality of second decoded messages comprises the second sequence of bits corresponding to the second part of data associated with the corresponding transmitting device amongst the plurality of transmitting devices 102, described earlier in detail, for example, in FIG. 8.

In accordance with an embodiment, decoding, by the decoding circuit 510, comprises receiving, by each decoder of a plurality of decoders (e.g., the plurality of decoders 520) of the decoding circuit 510, one of the first estimated symbol vectors and one of the second estimated symbol vectors, concatenating, by each decoder, the received first and second estimated symbol vectors into a concatenated estimated symbol vector, and decoding, by each decoder, the concatenated estimated symbol vector to generate a plurality of decoded messages, each decoded message comprising a first sequence of bits and a second sequence of bits, the first sequence of bits corresponding to a first part of data associated with a corresponding transmitting device amongst the plurality of transmitting devices 102, and the second sequence of bits corresponding to a second part of data associated with the corresponding transmitting device. Alternatively stated, each of the plurality of decoders 520 of the decoding circuit 510 is configured to receive the soft information in terms of one of the first estimated symbol vectors and one of the second estimated symbol vectors. Thereafter, each of the plurality of decoders 520 is configured to concatenate the received first and second estimated symbol vectors into the concatenated estimated symbol vector, and decode the concatenated estimated symbol vector to generate the plurality of decoded messages. Each decoded message comprises the first sequence of bits and the second sequence of bits, the first sequence of bits corresponds to the first part of data associated with the corresponding transmitting device (e.g., the first transmitting device 102A) amongst the plurality of transmitting devices 102, and the second sequence of bits corresponds to the second part of data associated with the corresponding transmitting device (e.g., the first transmitting device 102A) amongst the plurality of transmitting devices 102, described earlier in detail, for example, in FIG. 9.

In accordance with an embodiment, the method 1000 further comprises applying, by the splitting circuit 504, a predefined permutation matrix to the demodulated signals to generate the first baseband signals and the second baseband signals. In case of imperfect synchronization between each of the plurality of transmitting devices 102 (or the transmitting device 202) and the receiving device 104, the splitting circuit 504 is further configured to apply a predefined permutation matrix to the demodulated signals to generate the first baseband signals and the second baseband signals. The predefined permutation matrix corresponds to reverting the effect of the predefined permutation matrix used at the transmitting device 202 by applying the predefined permutation matrix to each of the first radio frequency signals at the receiving device 104. After applying the predefined permutation matrix to each of the first and second baseband signals, the plurality of first and second estimated symbol vectors is generated at the receiving device 104.

In accordance with an embodiment, the method 1000 further comprises estimating, by the separation circuit 506, a time offset and a frequency offset in each of the first estimated symbol vectors to generate a plurality of time offsets and a plurality of frequency offsets, and applying, by the separation circuit 506, a time offset compensation, based on the corresponding time offset, and a frequency offset compensation, based on the corresponding frequency offset, to the corresponding estimated symbol vector. In a case, when there is no block fading channel between each of the plurality of transmitting devices 102 (or the transmitting device 202) and the receiving device 104, timing and carrier frequency offsets occur at each of the plurality of transmitting devices 102 and are compensated at the receiving device 104. Therefore, the separation circuit 506 is further configured to estimate as well as compensate the timing and carrier frequency offsets at the receiving device 104.

Further, the method 1000 comprises generating, by the equalizing circuit 508, each of the second estimated symbol vectors based on the plurality of time offsets, the plurality of frequency offsets, the plurality of estimated precoding matrices and the plurality of estimated channel parameters.

The steps 1002 to 1018 are only illustrative and other alternatives can also be provided where one or more steps are added, one or more steps are removed, or one or more steps are provided in a different sequence without departing from the scope of the claims herein.

In one aspect, a computer program product is provided performing the method 1000 when executed by one or more processors (e.g., the processor 512 of the receiving device 104) in a computer system. In another aspect, a computer system is provided comprising one or more processors (e.g., the processor 512) and one or more memories (e.g., the memory 514), the one or more memories (i.e., the memory 514) storing program instructions which, when executed by the one or more processors (i.e., the processor 512), cause the one or more processors (i.e., the processor 512) to execute the method 1000.

In another aspect, a processor is provided comprising the various circuits configured to execute the method 1000, such as the demodulation circuit 503, the splitting circuit 504, the separation circuit 506, the equalizing circuit 508, and the decoding circuit 510.

In yet another aspect, the present disclosure provides a non-transitory computer-readable medium having stored thereon, computer-implemented instructions that, when executed by a computer, causes the computer to execute operations of the method 1000.

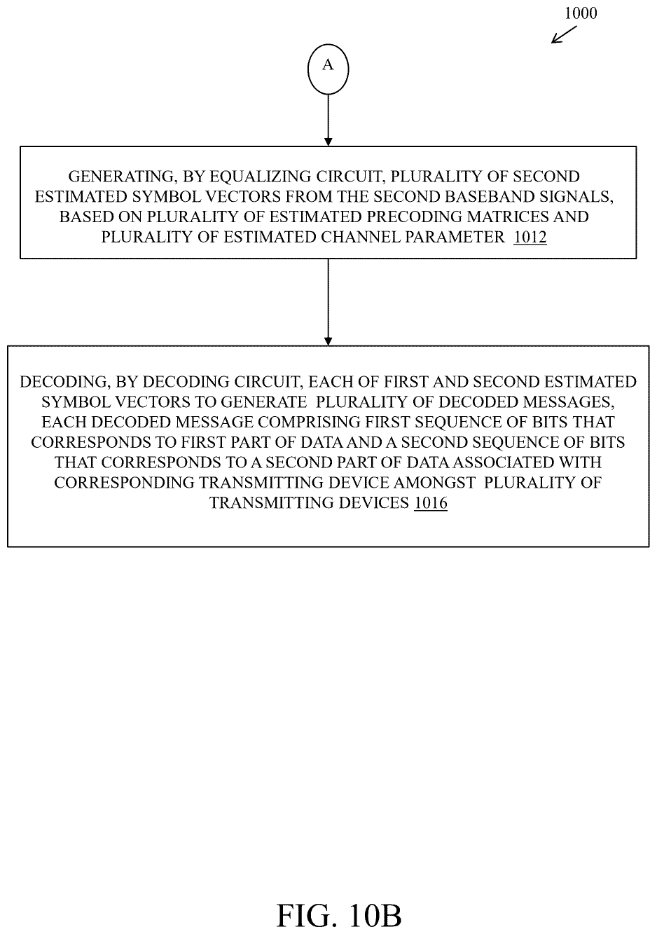

FIG. 11 is a block diagram that illustrates various exemplary components of a communication apparatus, in accordance with an embodiment of the present disclosure. FIG. 11 is described in conjunction with elements from FIGS. 1, 2A, 2B, 2C, 4, 5, 6, 7, 8, 9, 10A and 10B. With reference to FIG. 11, there is shown a block diagram 1100 of a communication apparatus 1102 that includes the transmitting device 202 (of FIG. 2A) and the receiving device 104 (of FIG. 1). In another embodiment, the communication apparatus 1102 may include the plurality of transmitting devices 102 and the receiving device 104.

The communication apparatus 1102 comprising the transmitting device 202 and the receiving device 104 manifests a reduced probability of decoding error rate, an improved communication reliability and spectral efficiency. Moreover, the communication apparatus 1102 may be used in the massive random-access scenario with the improved communication reliability and spectral efficiency. Examples of the communication apparatus 1102 may include, but are not limited to, a transceiver, a base station, a user equipment, and the like. The communication apparatus 1102 comprising the transmitting device 202 (or the plurality of transmitting devices 102) and the receiving device 104 can be used in Internet-of-Things (IOT), massive random-access scenario, uplink multi-input-multi-output (MIMO) random access with the plurality of transmitting devices 102, and the like.

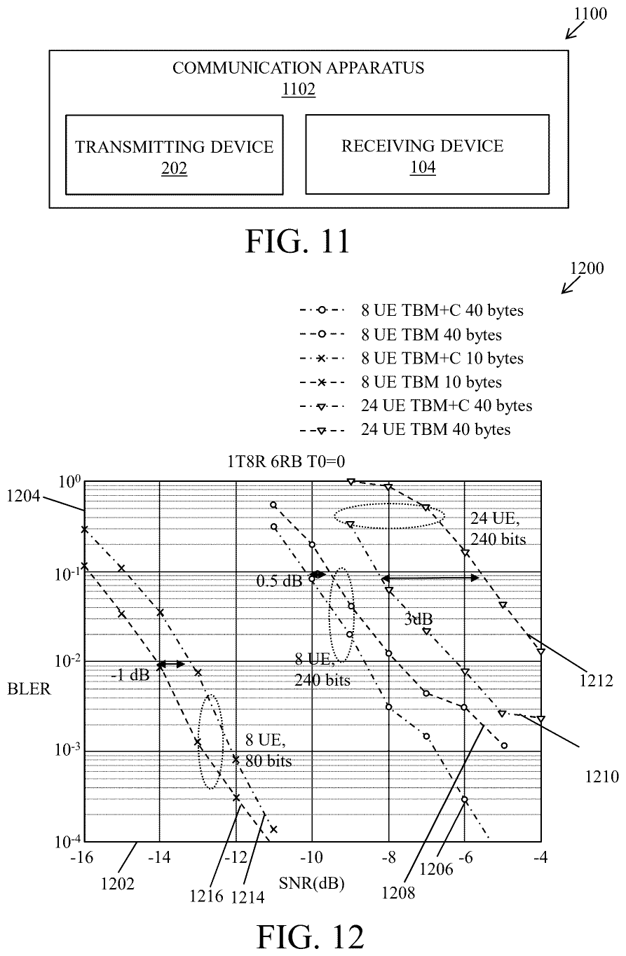

FIG. 12 is a graphical representation that illustrates variation of block error rate (BLER) with respect to signal-to-noise ratio (SNR) for a mixed tensor-based modulation and coherent modulation and a typical tensor-based modulation in case of large payloads, in accordance with an embodiment of the present disclosure. FIG. 12 is described in conjunction with elements from FIGS. 1, 2A, 2B, 2C, 3, 4, 5, 6, 7, 8, 9, 10A-10B, and 11. With reference to FIG. 12, there is shown a graphical representation 1200 with an X-axis 1202 that represents the SNR in decibel (dB) and a Y-axis 1204 that represents BLER.

The graphical representation 1200 illustrates the variation of BLER with respect to SNR in an ideal case where no timing and carrier frequency offsets are present. In an implementation, the graphical representation 1200 can be obtained by considering a packet size of either 10 bytes or 40 bytes, 8.24 active user equipments (UEs) or transmitting devices, two hundred and forty potential user equipments (UEs), a carrier frequency of 700 MHz, a bandwidth of 6 resource blocks (RBs), polar code for channel coding, 8 base station antennas, one UE antenna, channel model of TDL-A 30 ns and 3 Km/h, and with a numerology of SCS 15 kHz and 14 operating systems (OS). Moreover, the number of channel uses (i.e., T), p and q are 1008, 252, 756 or 378, respectively.

In the graphical representation 1200, there is shown a first line 1206 and a second line 1208. Each of the first line 1206 and the second line 1208 represents variation of BLER with respect to SNR that is obtained when eight user equipments (UEs) are transmitting a payload of 240 bits over a tensor-based modulation (TBM) along with the coherent modulation (may also be referred to as TBM+C) and the typical TBM, respectively. Moreover, the first line 1206 achieves a gain of 0.5 dB over the second line 1208. Alternatively stated, the TBM along with the coherent modulation (i.e., the TBM+C) represented by the first line 1206 achieves the gain of 0.5 dB over the typical TBM represented by the second line 1208. There is further shown a third line 1210 and a fourth line 1212. Each of the third line 1210 and the fourth line 1212 represents variation of BLER with respect to SNR that is obtained when twenty-four user equipments (UEs) are transmitting a payload of 240 bits over the TBM along with the coherent modulation (i.e., the TBM+C) and the typical TBM, respectively. Moreover, the third line 1210 achieves a gain of 3 dB over the fourth line 1212. Alternatively stated, the TBM along with the coherent modulation (i.e., the TBM+C) represented by the third line 1210 achieves the gain of 3 dB over the typical TBM represented by the fourth line 1212. There is further shown a fifth line 1214 and a sixth line 1216. Each of the fifth line 1214 and the sixth line 1216 represents variation of BLER with respect to SNR that is obtained when eight user equipments (UEs) are transmitting a payload of 80 bits over the TBM along with the coherent modulation (i.e., the TBM+C) and the typical TBM, respectively. Moreover, the fifth line 1214 achieves a loss of −1 dB over the sixth line 1216. Alternatively stated, the TBM along with the coherent modulation (i.e., the TBM+C) represented by the fifth line 1214 achieves the loss of −1 dB over the typical TBM represented by the sixth line 1216. In this way, it can be stated that the TBM along with the coherent modulation (i.e., the TBM+C) is preferred over the typical TBM when it transmits large payloads and with large number of users.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A transmitting device for random access communication, the transmitting device comprising:
an encoding circuit configured to:
encode an input message into a first sequence of bits and a second sequence of bits;
split the first sequence of bits into d blocks of bits, where d>1; and
determine d vectors, based on the d blocks of bits;
a first mapping circuit configured to construct a first symbol vector by computing a Kronecker product of the d vectors to generate a rank-1 tensor structure of order d;
a second mapping circuit configured to:
map the second sequence of bits to a vector of baseband symbols; and
apply an allocation matrix to the vector of baseband symbols to generate a second symbol vector, wherein the allocation matrix is a precoding matrix based on the first sequence of bits;
a concatenation circuit configured to concatenate the first symbol vector and the second symbol vector into a baseband symbol vector;
a modulation circuit configured to modulate the baseband symbol vector to generate a modulated symbol vector comprising modulated symbols; and
at least one antenna configured to transmit each modulated symbol of the modulated symbol vector in a radio frequency signal to a receiving device.

2. The transmitting device according to claim 1, wherein the encoding circuit is further configured to:
split the input message into a first message and a second message;
encode the first message into the first sequence of bits; and
encode the second message into the second sequence of bits.

3. The transmitting device according to claim 1, wherein the encoding circuit is further configured to encode the input message into a main sequence of bits, and split the main sequence of bits into the first sequence of bits and the second sequence of bits.

4. The transmitting device according to claim 1, wherein the encoding circuit is further configured to use a binary code for encoding messages.

5. The transmitting device according to claim 1, wherein the encoding circuit is further configured to select the precoding matrix from a fixed dictionary comprising matrices, wherein each of the matrices of the fixed dictionary is equal to one of a same unitary matrix, a same unitary matrix multiplied by a same permutation matrix, a same unitary matrix multiplied by a truncated permutation matrix from a set of non-disjoint truncated permutation matrices, a matrix from a set of matrices corresponding to subspaces of a Grassmannian space, or a matrix from a set of truncated unitary matrices.

6. The transmitting device according to claim 1, wherein the modulation circuit is further configured to map the baseband symbol vector in a time-frequency grid associated with a plurality of time-frequency resources according to a pre-defined allocation matrix associated with a multicarrier Orthogonal Frequency-Division Multiplexing modulation.

7. The transmitting device according to claim 1, wherein the first mapping circuit is further configured to multiply each of the d vectors by a unitary matrix, prior to computing the Kronecker product.

8. The transmitting device according to claim 1, wherein the second mapping circuit is configured to map the second sequence of bits to the vector of baseband symbols by using a quadrature amplitude modulation or a phase shift keying modulation.

9. The transmitting device according to claim 1, wherein the concatenation circuit is further configured to multiply the result of the concatenation of the first symbol vector and the second symbol vector by a permutation matrix to form the baseband symbol vector.

10. A receiving device for random access communication, comprising:
at least one antenna configured to receive a plurality of radio frequency signals concurrently from a plurality of transmitting devices;
a demodulation circuit configured to demodulate the received plurality of radio frequency signals into demodulated signals;
a splitting circuit configured to split the demodulated signals into first baseband signals and second baseband signals;
a separation circuit configured to:
generate a plurality of first estimated symbol vectors from the first baseband signals, using a rank-1 tensor structure of order d associated with each transmitting device, where d>1;
generate a plurality of estimated channel parameters associated with the plurality of transmitting devices and a plurality of estimated precoding matrices associated with the plurality of transmitting devices, based on the first baseband signals;
an equalizing circuit configured to:
generate a plurality of second estimated symbol vectors from the second baseband signals, based on the plurality of estimated precoding matrices and the plurality of estimated channel parameters; and
a decoding circuit configured to:
decode each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices.

11. The receiving device according to claim 10, wherein the decoding circuit comprises:
a plurality of first decoders each configured to decode one of the first estimated symbol vectors generated by the separation circuit to generate a plurality of first decoded messages, each first decoded message comprising a first sequence of bits corresponding to a first part of data associated with a corresponding transmitting device amongst the plurality of transmitting devices; and
a plurality of second decoders each configured to decode one of the second estimated symbol vectors generated by the equalization circuit to generate a plurality of second decoded messages, each of the second decoded messages comprising a second sequence of bits corresponding to a second part of data associated with a corresponding transmitting device amongst the plurality of transmitting devices.

12. The receiving device according to claim 10, wherein the decoding circuit comprises a plurality of decoders each configured to:
receive one of the first estimated symbol vectors and one of the second estimated symbol vectors,
concatenate the received first and second estimated symbol vectors into a concatenated estimated symbol vector, and
decode the concatenated estimated symbol vector to generate a plurality of decoded messages.

13. The receiving device according to claim 10, wherein the splitting circuit is further configured to apply a predefined permutation matrix to the demodulated signals to generate the first baseband signals and the second baseband signals.

14. The receiving device according to claim 10,
wherein the separation circuit is further configured to:
estimate a time offset and a frequency offset in each of the first estimated symbol vectors to generate a plurality of time offsets and a plurality of frequency offsets;
apply a time offset compensation, based on a corresponding time offset, and a frequency offset compensation, based on a corresponding frequency offset, to the corresponding first estimated symbol vector,
wherein the equalizing circuit is further configured to generate each of the second estimated symbol vectors based on the plurality of time offsets, the plurality of frequency offsets, the plurality of estimated precoding matrices and the plurality of estimated channel parameters.

15. A method for random access communication, comprising:
acquiring, by an encoding circuit of a transmitting device, an input message;
encoding, by the encoding circuit, the input message into a first sequence of bits and a second sequence of bits;
splitting, by the encoding circuit, the first sequence of bits in d blocks of bits, where d>1;
determining, by the encoding circuit, d vectors based on the d blocks of bits;
constructing a first symbol vector, by a first mapping circuit of the transmitting device, by computing a Kronecker product of the d vectors to generate a rank-1 tensor structure of order d;
mapping, by a second mapping circuit of the transmitting device, the second sequence of bits to a vector of baseband symbols;
applying, by the second mapping circuit, an allocation matrix to the vector of baseband symbols to generate a second symbol vector, wherein the allocation matrix is a precoding matrix based on the first sequence of bits;
concatenating, by a concatenation circuit of the transmitting device, the first symbol vector and the second symbol vector into a baseband symbol vector;
modulating, by a modulation circuit of the transmitting device, the baseband symbol vector to generate a modulated symbol vector comprising modulated symbols; and
transmitting, by at least one antenna of the transmitting device, each modulated symbol of the modulated symbol vector in a radio frequency signal to a receiving device.

16. The method according to claim 15, wherein encoding, by the encoding circuit, comprises:
splitting the input message into a first message and a second message,
encoding the first message into the first sequence of bits, and
encoding the second message into the second sequence of bits.

17. The method according to claim 15, wherein encoding, by the encoding circuit, comprises:
encoding the input message into a main sequence of bits; and
splitting the main sequence of bits into the first sequence of bits and the second sequence of bits.

18. A method for random access communication, comprising:
receiving, by at least one antenna of a receiving device, a plurality of radio frequency signals concurrently from a plurality of transmitting devices;
demodulating, by a demodulation circuit of the receiving device, the received radio frequency signals into demodulated signals;
splitting, by a splitting circuit of the receiving device, the demodulated signals into first baseband signals and second baseband signals;
generating, by a separation circuit of the receiving device, a plurality of first estimated symbol vectors from the first baseband signals, using a rank-1 tensor structure of order d associated with each transmitting device, where d>1;
generating, by the separation circuit, a plurality of estimated channel parameters associated with the plurality of transmitting devices and a plurality of estimated precoding matrices associated with the plurality of transmitting devices, based on the first baseband signals;
generating, by an equalizing circuit of the receiving device, a plurality of second estimated symbol vectors from the second baseband signals, based on the plurality of estimated precoding matrices and the plurality of estimated channel parameters;
decoding, by a decoding circuit of the receiving device, each of the first and second estimated symbol vectors to generate a plurality of decoded messages, each decoded message comprising a first sequence of bits that corresponds to a first part of data and a second sequence of bits that corresponds to a second part of data associated with a corresponding transmitting device amongst the plurality of transmitting devices.

19. The method according to claim 18, wherein decoding, by the decoding circuit, comprises:
decoding, by each first decoder of a plurality of first decoders of the decoding circuit, one of the first estimated symbol vectors to generate a plurality of first decoded messages, each first decoded messages comprising a first sequence of bits corresponding to a first part of data associated with a corresponding transmitting device amongst the plurality of transmitting devices; and
decoding, by each second decoder of a plurality of second decoders of the decoding circuit, one of the second estimated symbol vectors generated by the equalization circuit to generate a plurality of second decoded messages, each of the second decoded messages comprising a second sequence of bits that corresponds to a second part of data associated with a corresponding transmitting device amongst the plurality of transmitting devices.

20. The method according to claim 18, wherein decoding, by the decoding circuit, comprises:
receiving, by each decoder of a plurality of decoders of the decoding circuit, one of the first estimated symbol vectors and one of the second estimated symbol vectors;
concatenating, by each decoder, the received first and second estimated symbol vectors into a concatenated estimated symbol vector; and
decoding, by each decoder, the concatenated estimated symbol vector to generate a plurality of decoded messages.
